(19) United States
(12) Patent Application Publication
(10) Pub. No.: US 2024/0381259 A1
(43) Pub. Date: Nov. 14, 2024

(54) SYSTEMS AND METHODS FOR EFFICIENT COORDINATION IN A NETWORK FOR ENERGY MANAGEMENT

(71) Applicant: HFCL Limited, Bangalore (IN)

(72) Inventors: Subhas Chandra Mondal, Bangalore (IN); Satyanarayana Murthy Valluri, Bangalore (IN)

(73) Assignee: HFCL Limited, Bangalore (IN)

(21) Appl. No.: 18/659,521

(22) Filed: May 9, 2024

(30) Foreign Application Priority Data
May 10, 2023 (IN) 202341032946

(51) Int. Cl. H04W 52/02; H04L 5/00

(52) U.S. Cl. CPC H04W 52/0232; H04L 5/0053; H04W 52/0212

(57) ABSTRACT

Systems and methods for efficient coordination in a network for power management are described. In particular, the system (for example, a radio unit) monitors a downlink traffic at the radio unit in the network, and determines a low traffic state of the radio unit. Further, the system identifies a power consumption policy for the radio unit to enter a low power state, and communicates the power consumption policy and a set of parameters associated with the power consumption policy to a distributed unit and/or a management unit via an M-plane or a C-plane communication. Further, the system receives an offset time from the distributed unit based on the set of parameters. The system applies the power consumption policy at the radio unit on completion of the offset time. Therefore, by selecting an appropriate mode of communication, the systems and methods enable efficient coordination in the network.

### TECHNICAL FIELD

The present disclosure, in general, relates to managing communication in a wireless communication network, and in particular, relates to approaches for efficient coordination between control elements in the wireless communication network for energy or power management.

### BACKGROUND

A wireless radio channel suffers from high attenuation as the distance from a transmitter increases. The attenuation is higher at higher frequencies. In order to increase the inter-site distance of base stations, the transmit signal strength is boosted with a high-power amplifier (PA) to withstand the high attenuation. This makes the PA a vital component in any base station. In the fifth-generation (5G) new radio (NR) base station, the PA consumes more power to fulfil the demand for high traffic-streaming bitrates and high quality of service (QOS).

A radio unit at the base station with multiple radio frequency (RF) transceiver chains offers an opportunity to control the transmission power level based on the network demand from the end users, and the upper layer control elements like a distributed unit or a management and orchestration unit or a centralized unit may need to be aware of resource states at the radio unit in order to align resource scheduling with an optimized resource availability.

Conventional systems and methods do not provide a capability at the radio unit to intelligently identify an appropriate energy saving strategy and provide synchronization between the radio unit and the distributed unit for exchange of information related to power consumption or energy saving.

There is, therefore, a need in the art to provide systems and methods that can overcome the shortcomings of the current mechanisms.

### OBJECTS OF THE PRESENT DISCLOSURE

It is an object of the present disclosure to provide a solution for efficient coordination between control elements in a network architecture such as a radio unit, a distributed unit, and a management and orchestration unit.

It is an object of the present disclosure to optimize power consumption without any performance degradation.

It is an object of the present disclosure to facilitate synchronized coordination between the control elements for energy efficiency control originating from the radio unit.

### SUMMARY

In an aspect, the present disclosure relates to a method for managing communication in a wireless communication network. The method includes monitoring, by a processor associated with a radio unit, a downlink traffic at the radio unit in the wireless communication network at a first time instance, determining, by the processor, a low traffic state of the radio unit based on a pre-defined threshold for the monitored downlink traffic for a pre-configured time period, identifying, by the processor, a power consumption policy from a plurality of power consumption policies for the radio unit to enter a low power state based on the determined low traffic state, communicating, by the processor, the identified power consumption policy and a set of parameters associated with the identified power consumption policy to a distributed unit in the wireless communication network, receiving, by the processor, from the distributed unit, an offset time for the radio unit to enter the low power state, the offset time being based on the set of parameters associated with the identified power consumption policy, and applying, by the processor, the power consumption policy at the radio unit on completion of the offset time received from the distributed unit.

In an embodiment, the method may include determining, by the processor, another power consumption policy from the plurality of power consumption policies for the radio unit based on the monitored downlink traffic at a second time instance, the first time instance being prior to the second time instance, sending, by the processor, a message to the distributed unit to update the set of parameters based on the determined another power consumption policy, receiving, by the processor, from the distributed unit, an updated offset time for the radio unit to switch from the power consumption policy to the another power consumption policy, the updated offset time being based on the updated set of parameters associated with the determined another power consumption policy, and applying, by the processor, the another power consumption policy at the radio unit on completion of the updated offset time received from the distributed unit.

In an embodiment, the method may include receiving, by the processor, from the distributed unit, a second offset time for the radio unit to switch from the low power state to a normal state based on a predicted downlink traffic at the radio unit, and configuring, by the processor, the radio unit to enter the normal state on completion of the second offset time received from the distributed unit.

In an embodiment, the method may include receiving, by the processor, from a management unit in the wireless communication network, a message indicating the power consumption policy for the radio unit based on the low traffic state of the radio unit, and analyzing, by the processor, a power saving potential associated with the power consumption policy.

In an embodiment, the method may include sending, by the processor, an acknowledgement for the power consumption policy to the management unit based on the power saving potential associated with the power consumption policy.

In an embodiment, the method may include determining, by the processor, another power consumption policy from the plurality of power consumption policies for the radio unit based on the power saving potential associated with the power consumption policy and the another power consumption policy, communicating, by the processor, the determined another power consumption policy to the management unit, and receiving, by the processor, from the management unit, an acknowledgement for the another power consumption policy for the radio unit, where the acknowledgement may include one of: a positive acknowledgement for the another power consumption policy, or a negative acknowledgement for the another power consumption policy, and where in case of the negative acknowledgment, the method may include sending, by the processor, an acknowledgement for the power consumption policy to the management unit.

In an embodiment, the method may include in response to communicating the power consumption policy to the distributed unit, receiving, by the processor, from the distributed unit, an indication of another power consumption policy from the plurality of power consumption policies for the radio unit based on the monitored downlink traffic and a predicted downlink traffic, analyzing, by the processor, a power saving potential associated with the power consumption policy and the another power consumption policy, communicating, by the processor, the another power consumption policy to a management unit in the wireless communication network based on the power saving potential associated with the another power consumption policy, and receiving, by the processor, from the management unit, a positive acknowledgement for the another power consumption policy.

In an embodiment, the communication between the radio unit and the distributed unit may be via one of a management-plane (M-plane) based communication, and a control-plane (C-plane) based communication, based on a symbol level power control mechanism, where the communication between the radio unit and the distributed unit may be via the M-plane based communication based on the symbol level power control mechanism being disabled, and where the communication between the radio unit and the distributed unit may be via the C-plane based communication based on the symbol level power control mechanism being enabled.

In an embodiment, the set of parameters for the M-plane based communication may include at least one of an identifier of the radio unit, a bit corresponding to the low power state of the radio unit, a type of the power consumption policy, a predicted traffic rate, a number of transmit/receive chains to be disabled, a number of downlink slots to be disabled, a start slot number, and a maximum number of physical resource blocks (PRBs) per each symbol.

In an embodiment, the C-plane based communication may include an exchange of C-plane packets between the radio unit and the distributed unit, where each C-plane packet may include at least an extension flag, where each C-plane packet may include extension fields based on the extension flag being enabled, where the extension fields may include at least one of extension type, extension length, energy saving type, and the set of parameters, and where the set of parameters may include at least one of number of PRBs per symbol, start slot, and number of slots.

In another aspect, the present disclosure relates to a method for managing communication in a wireless communication network. The method includes receiving, by a processor associated with a distributed unit, from a radio unit in the wireless communication network, a set of parameters associated with a power consumption policy of a plurality of power consumption policies, determining, by the processor, an offset time for a scheduler to change a configuration from a first scheduling scheme to a second scheduling scheme corresponding to the power consumption policy, and sending, by the processor, the offset time to the radio unit to enter a low power state based on applying the power consumption policy on completion of the offset time.

In an embodiment, the method may include determining, by the processor, a predicted downlink traffic at the radio unit, sending, by the processor, an indication to the scheduler to change the configuration from the second scheduling scheme to the first scheduling scheme based on the predicted downlink traffic, and sending, by the processor, a message to the radio unit to switch from the low power state to a normal state based on the predicted downlink traffic.

In an embodiment, the method may include in response to receiving the set of parameters associated with the power consumption policy from the radio unit, determining, by the processor, another power consumption policy from the plurality of power consumption policies for the radio unit based on a current downlink traffic and a predicted downlink traffic, communicating, by the processor, the another power consumption policy to the radio unit, receiving, by the processor, from the radio unit, an acknowledgement for the another power consumption policy, determining, by the processor, an updated set of parameters associated with the another power consumption policy and an updated offset time for the scheduler to change the configuration, and sending, by the processor, the updated offset time to the radio unit to enter the low power state based on applying the another power consumption policy on completion of the updated offset time.

In an embodiment, the communication between the distributed unit and the radio unit may be via a management-plane (M-plane) based communication based on a symbol level power control mechanism being disabled, and via a control-plane (C-plane) based communication based on the symbol level power control mechanism being enabled.

In an embodiment, the C-plane based communication may include an exchange of C-plane packets between the radio unit and the distributed unit, where each C-plane packet may include at least an extension flag, where each C-plane packet may include extension fields based on the extension flag being enabled, where the extension fields may include at least one of extension type, extension length, energy saving type, and the set of parameters, and where the set of parameters may include at least one of number of PRBs per symbol, start slot, and number of slots.

In another aspect, the present disclosure relates to a method for managing communication in a wireless communication network. The method includes monitoring, by a processor associated with a management unit, a downlink traffic at a radio unit in the wireless communication network, determining, by the processor, a low traffic state of the radio state based on a pre-defined threshold for the monitored downlink traffic, determining, by the processor, a power consumption policy from a plurality of power consumption policies and a set of parameters associated with the determined power consumption policy for the radio unit to enter a low power state based on the determined low traffic state, and communicating, by the processor, the determined power consumption policy and the set of parameters to the radio unit.

In an embodiment, the method may include receiving, by the processor, an acknowledgement for the power consumption policy from the radio unit.

In an embodiment, the method may include receiving, by the processor, from the radio unit, a message indicating another power consumption policy from the plurality of power consumption policies based on a power saving potential associated with the another power consumption policy, and sending, by the processor, an acknowledgement for the another power consumption policy to the radio unit, where the acknowledgment may include one of a positive acknowledgement or a negative acknowledgement.

In an aspect, the present disclosure relates to a radio unit for managing communication in a wireless communication network, where the radio unit may perform the steps of the method as described above.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1A illustrates an exemplary network architecture in which or with which the proposed mechanism may be implemented, in accordance with an embodiment of the present disclosure.

FIG. 1B illustrates an exemplary high-level system architecture of a radio access network (RAN), in accordance with an embodiment of the present disclosure.

FIGS. 2A-2C illustrate exemplary representations of packet structures, as defined in Open-RAN (O-RAN) control, user, and synchronization plane, in accordance with embodiments of the present disclosure.

FIG. 3 illustrates an exemplary representation of scheduling by a radio resource management (RRM) scheduler, in accordance with embodiments of the present disclosure.

FIG. 4 illustrates an exemplary representation of a call flow from a radio unit to an RRM scheduler in a distributed unit, in accordance with embodiments of the present disclosure.

FIGS. 5A-5D illustrate exemplary representations of RRM scheduler resource grids, in accordance with embodiments of the present disclosure.

FIG. 6 illustrates an exemplary representation of a state transition diagram for a radio unit in a management-plane (M-plane) message based communication, in accordance with embodiments of the present disclosure.

FIGS. 7A-7H illustrate exemplary sequence flow diagrams for managing communication of energy saving information in a network, in accordance with embodiments of the present disclosure.

FIG. 8 illustrates a message format for control-plane (C-plane) message based communication, in accordance with embodiments of the present disclosure.

FIG. 9 illustrates a section extension for C-plane message based communication for energy saving, in accordance with embodiments of the present disclosure.

FIG. 10 illustrates an exemplary flow chart of a method for managing communication in a wireless communication network, in accordance with embodiments of the present disclosure.

FIG. 11 illustrates an exemplary computer system in which or with which the proposed mechanism may be implemented, in accordance with an embodiment of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Multiple-input multiple-output (MIMO) may refer to a technique that uses multiple transmit antennas and/or multiple receive antennas to wirelessly transmit a signal across a wireless communication network, for example, two or four antennas at the transmitter and/or the receiver. Massive MIMO utilizes an even higher number of antennas than traditional MIMO, for example, tens or hundreds (8, 16, 32, 64, etc.) of antennas at the transmitter and/or the receiver. With the deployment of massive MIMO active radios in Third Generation Partnership Project (3GPP) Fifth Generation (5G) wireless networks, there is an increased power consumption in the digital signal processing block of the radio unit in 5G. While network operators can provide higher throughput using 5G networks, the associated increase in radio unit power consumption in 5G radios is undesirable. During off-peak times of the day or night, it is unnecessary to provide the high throughput capability. Therefore, the radio unit may detect and enter into an energy saving state or power consumption policy by reducing the usage of radio resources intelligently. It may be appreciated that the upper layer control elements like a distributed unit and a centralized unit may need to be aware of the radio unit's resource states to align resource scheduling based on the optimized resource availability.

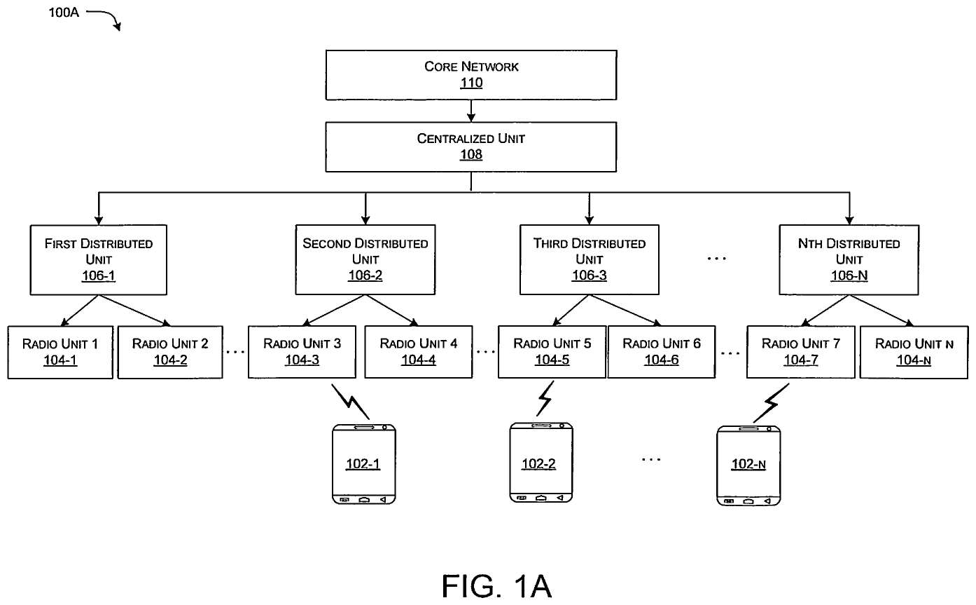

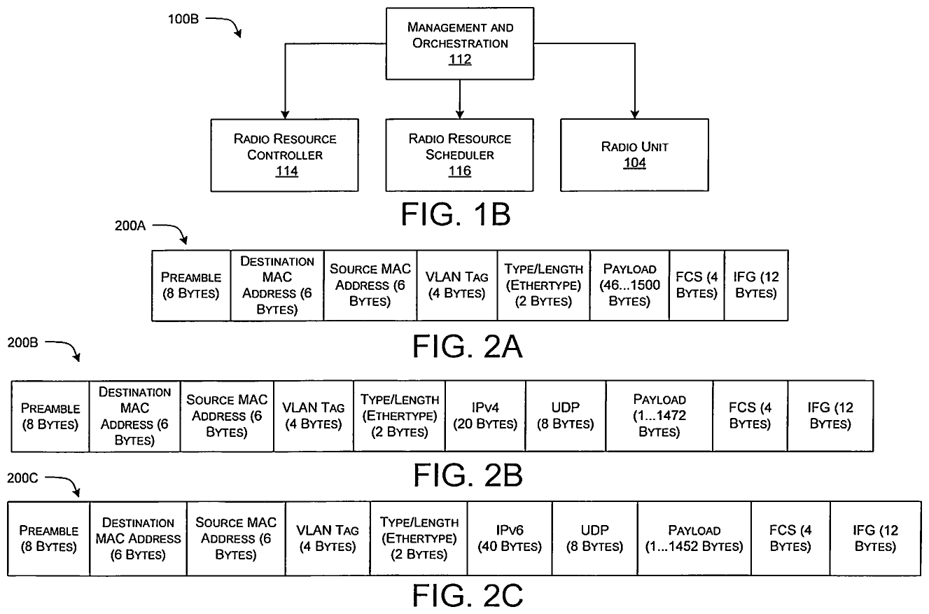

Accordingly, the present disclosure relates to a system and a method for efficient coordination between the control elements in a wireless communication network to exchange power saving information. The various embodiments throughout the disclosure will be explained in more detail with reference to FIGS. 1-11.

FIG. 1A illustrates an exemplary network architecture 100A for implementing the proposed mechanism, in accordance with an embodiment of the present disclosure.

In particular, the exemplary network architecture 100A may represent a communication system such as a 5G or next-generation communications system. In an embodiment, the network architecture 100A may include one or more computing devices (102-1, 102-2 . . . 102-N), one or more radio units (104-1, 104-2 . . . 104-N), one or more distributed units (106-1, 106-2 . . . 106-N), a centralized unit 108, and a core network 110. The centralized unit 108 may communicate with the one or more distributed units (106-1, 106-2 . . . 106-N) in a wired or a wireless manner. Further, a first distributed unit 106-1 may communicate with a first radio unit 104-1 and a second radio unit 104-2. Similarly, a second distributed unit 106-2 may communicate with a third radio unit 104-3 and a fourth radio unit 104-4. Furthermore, the one or more computing devices (102-1, 102-2 . . . 102-N) may be communicatively connected to the one or more radio units (104-1, 104-2 . . . 104-N). For example, a first computing device 102-1 may be connected to the third radio unit 104-3. It may be appreciated that there can be any number of distributed units (106-1, 106-2 . . . 106-N) connected to the centralized unit 108. Further, there can be any number of radio units (104-1, 104-2 . . . 104-N) connected to each of the one or more distributed units (106-1, 106-2 . . . 106N). Similarly, there can be any number of computing devices (102-1, 102-2 . . . 102-N) connected to the one or more radio units (104-1, 104-2 . . . 104-N). A person of ordinary skill in the art may understand the one or more distributed units (106-1, 106-2 . . . 106-N) may be collectively referred as the distributed units 106 and individually referred as the distributed unit 106. Further, the one or more radio units (104-1, 104-2 . . . 104-N) may be collectively referred as the radio units 104 and individually referred as the radio unit 104. Similarly, the one or more computing devices (102-1, 102-2 . . . 102-N) may be collectively referred as the computing devices 102 and individually referred as the computing device 102.

In an embodiment, the computing devices 102 may move between different radio units 104, for example, from a first radio unit 104-1 to a second radio unit 104-2, both served by a first distributed unit 106-1. In an embodiment, the computing devices 102 may move between different distributed units 106, for example, from the first distributed unit 106-1 to the second distributed unit 106-2 and vice versa.

Referring to FIG. 1A, the centralized unit 108 and/or the distributed units 106 may be coupled to the core network 110 of an associated wireless network operator. In an embodiment, the centralized unit 108 may be responsible for centralized radio resource and connection management control. In another embodiment, the distributed units 106 may include a processing function for implementing a distributed user plane and process a physical layer function and a layer-2 function.

In an embodiment, the computing devices 102 may include, but not be limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the computing devices 102 may communicate with the distributed units 106 via set of executable instructions residing on any operating system. In an embodiment, the computing devices 102 may include, but are not limited to, any electrical, electronic, electro-mechanical or an equipment or a combination of one or more of the above devices such as virtual reality (VR) devices, augmented reality (AR) devices, laptop, a general-purpose computer, desktop, personal digital assistant, tablet computer, mainframe computer, or any other computing device, wherein the computing device 102 may include one or more in-built or externally coupled accessories including, but not limited to, a visual aid device such as camera, audio aid, a microphone, a keyboard, input devices for receiving input from a user such as touch pad, touch enabled screen, electronic pen and the like.

It may be appreciated that the computing devices 102 may not be restricted to the mentioned devices and various other devices may be used.

Although FIG. 1A shows exemplary components of the network architecture 100A, in other embodiments, the network architecture 100A may include fewer components, different components, differently arranged components, or additional functional components than depicted in FIG. 1A. Additionally, or alternatively, one or more components of the network architecture 100A may perform functions described as being performed by one or more other components of the network architecture 100A.

FIG. 1B illustrates an exemplary high-level system architecture 100B of a radio access network (RAN), in accordance with an embodiment of the present disclosure.

In particular, the system architecture 100B of the RAN may include a management and orchestration unit 112 (or a service management and orchestration unit 112 or an Open-radio unit controller 112 or a management unit 112), a radio resource controller 114, a radio resource scheduler 116, and a radio unit 104. It may be appreciated that the radio unit 104 of FIG. 1B may be similar to the radio unit 104 of FIG. 1A in its functionality. In an embodiment, the system architecture 100B may be implemented as a 5G New Radio (NR) RAN that supports a 5G NR wireless interface in accordance with the 5G NR specifications and protocols specified by the 3GPP and Open RAN (O-RAN). In an embodiment, in a disintegrated RAN architecture, the radio resource controller 114 may be implemented as a centralized unit such as the centralized unit 108 of FIG. 1A. Further, radio link control (RLC) and media access control (MAC) may be performed in the radio resource scheduler 116 that may be implemented in or as a distributed unit such as the distributed unit 106 of FIG. 1A.

Referring to FIG. 1B, the management and orchestration unit 112 may be communicatively coupled to the radio resource controller 114, the radio resource scheduler 116, and/or the radio unit 104. The management and orchestration unit 112 may send and receive management communications to and from the radio resource controller 114, which in turn may forward relevant management communications to and from the radio unit 104. In some embodiments, communication between the radio unit 104 and the radio resource scheduler 116 may occur in management-plane (M-plane). In some embodiments, communication between the management and orchestration unit 112 and the radio unit 104 or the radio resource scheduler 116 may happen in O1 interface. Proprietary protocols and interfaces may be used for such M-plane communications. Also, protocols and interfaces that are specified by standards such as 5G specifications in 3GPP and O-RAN may be used for such M-plane communications.

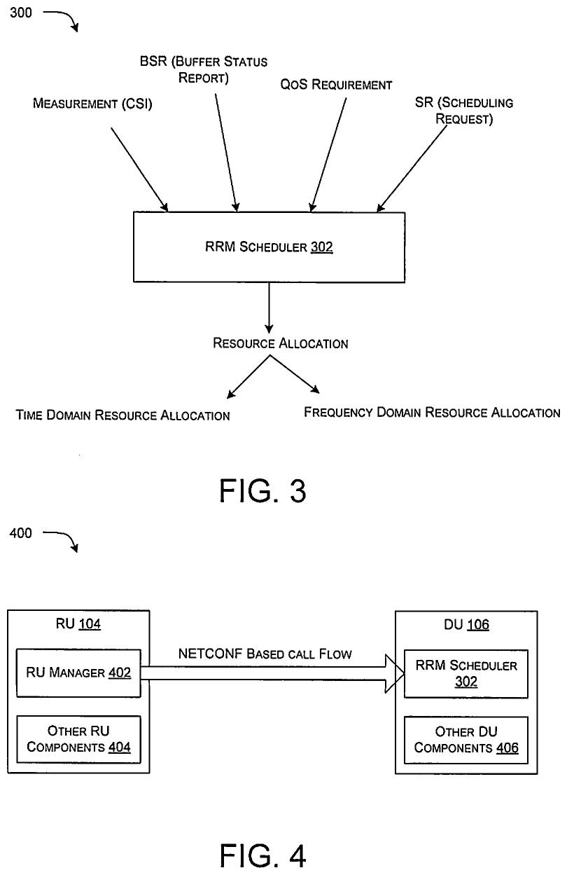

Referring to FIG. 1B, the radio unit 104 may include or be coupled to one or more antennas (not shown) via which downlink radio frequency signals may be radiated to computing devices (for example, the computing devices 102 of FIG. 1A) and via which uplink radio frequency signals transmitted by the computing devices 102 may be received. In an embodiment, the radio unit 104 may take an input from the radio resource scheduler 116 (i.e., distributed unit 106) and transmit radio frequency signal(s) over the air interface (as shown in FIG. 1A). In an embodiment, the radio resource controller 114 may maintain a count of a number of connected users such as the computing devices 102 for each radio unit 104. Based on the number of connected computing devices 102, the radio resource controller 114 may control the radio resource scheduler 116 to schedule radio resources. In an embodiment, the radio resource scheduler 116 may determine an amount of data to be transmitted by the radio unit 104. This is explained in detail with reference to FIG. 3.

In an embodiment, pre-defined data models may be used for exchange of data between the radio unit 104 and the radio resource scheduler 116 (i.e., distributed unit 106). In an exemplary embodiment, the pre-defined data model may be a yet another next generation (YANG) model. In an embodiment, the radio unit 104 may measure traffic data based on O-RAN defined YANG parameters for performance management. The radio unit 104 may send the measured traffic data to the management and orchestration unit 112. In an embodiment, the management and orchestration unit 112 may calculate traffic rate based on the traffic data received from the radio unit 104. This offloads the radio unit 104 from additional computational load, which may impact real-time data processing at the radio unit 104.

In an embodiment, a network configuration protocol (NETCONF) session may be established between the radio unit 104 and the radio resource scheduler 116 (i.e., 106), post which start-up configuration may be completed. Further, the radio unit 104 may monitor its traffic conditions based on physical resource block (PRB) utilization. In an embodiment, the radio unit 104 may monitor its traffic conditions either continuously or in pre-defined time intervals. When traffic rate goes below a pre-defined threshold, the radio unit 104 may switch off a pre-determined number of power amplifiers (PAs) in the radio unit 104 to decrease overall power consumption at the radio unit 104.

In an embodiment, the management and orchestration unit 112 may measure the actual downlink traffic at the radio unit 104 at a particular time instance in order to determine a low traffic state of the radio unit 104 based on the pre-defined threshold. In an embodiment, if the monitored downlink traffic is within the pre-defined threshold for a pre-configured time period, the radio unit 104 (or the management and orchestration unit 112) may determine the low traffic state of the radio unit 104. Else, the radio unit 104 and/or the management and orchestration unit 112 may continue to monitor the downlink traffic at the radio unit 104.

In another embodiment, the radio unit 104 may measure the actual downlink traffic by calculating PRB utilization or by calculating user-plane (U-plane) utilization. In some embodiments, the radio unit 104 may predict traffic rate based on historical traffic data. The management and orchestration unit 112 may collect the traffic related data from the radio unit 104 on a periodic basis, and calculate the traffic rate for a pre-configured time period. Based on the collected traffic related data, the management and orchestration unit 112 may send the computed traffic rate to the radio unit 104. The radio unit 104 may identify an appropriate energy saving strategy or a power consumption policy based on the computed traffic rate. It may be appreciated that the “energy saving scheme,” “energy saving state,” “energy saving strategy,” and “power consumption policy” may be used interchangeably herein.

In an embodiment, communication from the radio unit 104 to the management and orchestration unit 112 may happen via NETCONF protocol and YANG data models, where each data model may consist of different parameters. In an embodiment, the below table 1 gives an overview of YANG parameters as defined in O-RAN performance management.

TABLE 1

| | | | | |
|---|---|---|---|---|
| RX-WINDOW-STATS | RX_ON_TIME | COUNT | RU, | TYPE YANG: COUNTER64 IS |
| | RX_EARLY | | TRANSPORT, | USED FOR THE COUNT. |
| | RX_LATE | | OR EAXC_ID | WHEN OBJECT-UNIT IS |
| | RX_CORRUPT | | | EAXC_ID, TRANSPORT IS |
| | RX_DUPL | | | REPORTED AS ADDITIONAL |
| | RX_DUPL | | | PARAMETER FOR |
| | RX_ON_TIME_C | | | EAXC_ID. |
| | RX_EARLY_C | | | |
| | RX_LATE_C | | | |
| | RX_SEQID_ERR | | | |
| | RX_SEQID_ERR_C | | | |
| | RX_ERR_DROP | | | |

In an embodiment, a number of parameters from performance management YANG model may be used to calculate a current downlink traffic at the radio unit 104. For example, measurement interval for rx-window-statistics, as depicted in table 1, may refer to a parameter that specifies the time interval over which the rx-window-statistics may be measured. For example, the management and orchestration unit 112 may set the measurement interval to be 5 minutes, 10 minutes, etc. Further, as an example, rx-total-packets may refer to a total number of packets received in a particular measurement interval time as set by the management and orchestration unit 112 in the above parameter, i.e., measurement interval. In an embodiment, the current downlink traffic may be calculated as a traffic data rate by the following formula:

$$Traffic Data Rate = Total Received Packets * Packet Size / Measurement Time Interval$$

FIGS. 2A-2C illustrate exemplary representations (200A, 200B, 200C) of packet structures, as defined in O-RAN control, user, and synchronization plane, in accordance with embodiments of the present disclosure.

In particular, FIG. 2A illustrates an exemplary representation 200A of an O-RAN control, user, and synchronization plane defined Ethernet packet header. FIG. 2B illustrates an exemplary representation 200B of an O-RAN control, user, and synchronization plane defined internet protocol (IP) packet header for native IPv4 packet with virtual local area network (VLAN). FIG. 2C illustrates an exemplary representation 200C of an O-RAN control, user, and synchronization plane defined IP packet header for native IPv6 packet with VLAN.

As an example, with reference to FIG. 2A, maximum data for 1 Ethernet packet=1542 bytes=1542*8=12336 bits. The payload for each packet may be 1500 bytes=12000 bits. Therefore, a current downlink traffic data rate may be calculated as:

$${Datarate}_{DL\_total} = \frac{Total packets * Bytes per each packet}{time period}$$

Where, total packets may be rx-total, Bytes per each packet may be 1500, and time period may be measurement time interval.

In an embodiment, a radio unit (e.g., 104) may receive radio frequency signals in the form of In-phase (I) and Quadrature-phase (Q) symbols, referred to as IQ symbols. In an O-RAN architecture, the IQ symbols may be transported over a fronthaul link to the radio unit 104 over an enhanced common public radio interface (eCPRI). In case of an integrated distributed unit and radio unit scenario, the IQ symbols may be transported over a CPRI. In an O-RAN 7.2x split, a distributed unit (e.g., 106) and the radio unit 104 may be disaggregated over a fronthaul eCPRI.

In an embodiment, the radio unit 104 may maintain a plurality of counters to monitor traffic statistics of the data to be transmitted over one or more associated antennas. The downlink data to be transmitted over the antennas comes over the eCPRI link and the radio unit 104 measures U-plane data rate over a measurement window, for example, Rx window measurement interval.

In an embodiment, U-plane link utilization may depict how much U-plane traffic may be present in total downlink traffic. The below table 2 depicts different eCPRI header values for different eCPRI message types.

TABLE 2

| e-CPRI header values | e-CPRI message type |
|---|---|
| 0000 0000b | U-plane packet (IQ-data) |
| 0000 0010b | C-plane packet |
| 0000 0101b | Transport delay message |

In an embodiment, eCPRI message type, part of eCPRI common header, may specify the packet type. The information related to packet type may be in the 2nd octet. Therefore, from the e-CPRI message header values, the radio unit 104 may identify a number of U-plane packets, and may calculate the U-plane link utilization for a particular period of time as:

$${Datarate}_{U - plane} = \frac{{Packets}_{UP} * Bytes per packet}{Time period}$$

Based on calculating the U-plane data rate, the radio unit 104 may calculate the U-plane link utilization as:

$$U - plane link Utlization = \frac{{Datarate}_{U - plane}}{{Datarate}_{DL\_total}}$$

In an embodiment, as discussed above, the radio unit 104 may monitor the downlink traffic at the radio unit 104 at a particular time instance (e.g., a first-time instance). Further, the radio unit 104 may determine a low traffic state of the radio unit 104 based on the pre-defined threshold for the monitored downlink traffic for a pre-configured time period. In another embodiment, a management and orchestration unit (e.g., 112) may monitor the downlink traffic at the radio unit 104 at the first-time instance, and determine the low traffic state of the radio unit 104. Further, in an embodiment, an energy saving scheme or a power consumption policy may be identified for the radio unit 104 to enter a low power state based on the low traffic state of the radio unit 104. In an embodiment, the radio unit 104 may select the power consumption policy from a plurality of power consumption policies based on a computation of power saving potential of the power consumption policy. In an embodiment, the radio unit 104 may be configured to share summarized data trend (for example, 10-minute time interval) for a defined time duration (for example, 1 week), to the management and orchestration unit 112 for network wide power optimization. In an embodiment, the defined time duration may include, but not be limited to, daily trend, weekly trend, monthly trend, and the like.

In an embodiment, the radio unit 104 and/or the distributed unit 106 and/or the management and orchestration unit 112 may select the power consumption policy for the radio unit 104 to enter the low power state based on factors including, but not limited to, monitored downlink traffic, predicted downlink traffic, U-plane link utilization, etc. In an embodiment, the selected power consumption policy may be applied at the radio unit 104 for a pre-defined time interval. In an embodiment, the power consumption policy may include, but not be limited to, a first power consumption policy, a second power consumption policy, and a third power consumption policy. In an embodiment, the radio unit 104 and/or the distributed unit 106 and/or the management and orchestration unit 112 may select the power consumption policy based on a power saving potential of each of the first power consumption policy, the second power consumption policy, and the third power consumption policy. In an embodiment, the third power consumption policy may be a combination of the first power consumption policy and the second power consumption policy. It may be appreciated that the terms “first,” “second,” and “third” are used for illustrative purposes only, and the first power consumption policy may refer to any power consumption policy, i.e., first, second, or third power consumption policy. The same may apply for second and/or third power consumption policies.

In an embodiment, the power consumption policies may be related to the PRBs, time slots, and/or transmit-receive chains. In some embodiments, if U-plane link utilization is below the pre-defined threshold, then a maximum number of PRBs per symbol may be determined as:

$${PRB}_{per symbol} = Threshold * 273$$

Based on the PRB utilization trend, the radio unit 104 may calculate a number of additional PRBs P0, so that the radio unit 104 may deliver power to all the PRBs taking variance into account. As an example, considering last 5 PRB utilization values as x1, x2, x3, x4, and x5. Now, mean of the last 5 PRB utilization values (M)=(x1+x2+x3+x4+x5)/5. Now, P0=max (M−x1, M−x2, M−x3, M−x4, M−x5). It may be appreciated that the radio unit 104 may consider any number of last PRB utilization values (in this example, it has been considered as 5). In an embodiment, this number of the last PRB utilization values may be updated either by the radio unit 104 and/or by the management and orchestration unit 112.

Further, in an embodiment, if the U-plane link utilization is below the pre-defined threshold, the radio unit 104 may disable a number of downlink timeslots present in the tdd_UL_DL_configuration. The number of downlink timeslots may be calculated as:

$${newDL}_{slots} = U plane link utilization * {DL}_{totalslots}$$

Furthermore, in an embodiment, if the U-plane link utilization is below the pre-defined threshold, the radio unit 104 may switch off some transmit-receive chains, and make changes in network configuration.

Therefore, the radio unit 104 may identify any power consumption policy, either from the above (i.e., modifying PRBs, timeslots, or transmit-receive chains) or otherwise within the scope of ongoing disclosure, for the radio unit 104 to enter the low power state. In an embodiment, the radio unit 104, based on identifying the power consumption policy, may communicate the same to the distributed unit 106 by sharing a set of parameters or energy saving parameters or power consumption parameters associated with the identified power consumption policy, In an embodiment, the set of parameters may include, but not limited to, PRB_per_symbol, start_slot, number_of_slots, and number_of_tx-rx_chains. The PRB_per_symbol may refer to a maximum number of PRBs to be allocated per symbol. The start_slot and number_of_slots may indicate the distributed unit 106 to disable the number_of_slots starting from the start_slot in downlink. Further, the number_of_tx-rx_chains may refer to a number of transmit-receive chains to be switched off. The radio unit 104 may send these set of parameters to the distributed unit 106 to indicate the identified power consumption policy for the radio unit 104 to enter the low power state.

Alternatively, or additionally, the radio unit 104 may share the current traffic related data to the management and orchestration unit 112 to offload computational complexity of the radio unit 104. That is, the management and orchestration unit 112 may identify an appropriate power consumption policy for the radio unit 104 based on the current traffic related data of the radio unit 104, and communicate the identified power consumption policy to the radio unit 104. In an embodiment, the management and orchestration unit 112 may consider historical traffic condition pattern of the radio unit 104 in addition to the current traffic related data to identify the appropriate power consumption policy for the radio unit 104. In another embodiment, the distributed unit 106 may identify an appropriate power consumption policy for the radio unit 104 based on the current traffic related data and a predicted traffic (based on historical traffic condition pattern). In an embodiment, the radio unit 104 and/or the distributed unit 106 and/or the management and orchestration unit 112 may predict the downlink traffic at the radio unit 104 for a pre-defined time interval, for example, for 30 minutes. The prediction may be performed based on historical data pattern of the downlink traffic at the radio unit 104.

Therefore, before the radio unit 104 switches into the identified power consumption policy/energy saving state, i.e., low power state, the radio unit 104 may send the set of energy saving parameters to the distributed unit 106 to ensure coordination between the control elements. This is essential, because after applying the power consumption policy, for example, switching off transmit-receive chains or some Pas, the radio unit 104 may have to manage user traffic with the number of Pas which are in active state. Now, if the distributed unit 106 may not be aware about the low power state of the radio unit 104, and may send the user traffic scheduled normally, it may lead to loss of data or few data packets may be dropped.

Therefore, in accordance with embodiments of the present disclosure, there is proposed an efficient mechanism for establishing and/or maintaining coordination between the radio unit 104, the distributed unit 106, and the management and orchestration unit 112 over existing standard interfaces for efficient energy/power management. In an embodiment, the radio unit 104 and the distributed unit 106 may communicate using one of the two approaches: M-plane message based communication, or control-plane (C-plane) message based communication.

### M-Plane Message Based Communication

In an embodiment, the communication between the radio unit 104 and the distributed unit 106 may be via M-plane for management using YANG data models, as discussed herein. In an embodiment, based on identifying the power consumption policy, the radio unit 104 may communicate the same to the distributed unit 106 via the M-plane. In such communication, the radio unit 104 may send the set of parameters (i.e., energy saving parameters) to exchange energy saving information with the distributed unit 106. As described above, the communication between the radio unit 104 and the distributed unit 106 may occur in M-plane for management using YANG data models for exchanging the information.

In an embodiment, the set of energy saving parameters for M-plane message based communication may include, but not be limited to, RU_ID, Energy Saving (ES), ES_type, predicted_data_rate, number_of_tx-rx_chains, number_of_DL_slots, start_slot, PRBs_per_symbol, and the like. The parameter RU_ID may identify the associated radio unit (e.g., 104). The RU_ID may be an IP address or a domain name of the radio unit 104. For example, the RU_ID may be Ipv6 address of 128 bits. Further, the parameter Energy Saving (ES) may identify whether energy saving is enabled or not. The Energy Saving (ES) parameter may be a Boolean type parameter, having values of 0 or 1, of 1 bit. Furthermore, the parameter ES_type may identify which energy saving scheme (or, power consumption policy) is to be enabled. The ES_type parameter may be an integer type parameter, having values from 0-3, of 2 bits. The parameter predicted_data_rate may refer to predicted data rate at a particular time instance. The predicted_data_rate parameter may be an integer type parameter of 14 bits. Further, the parameter number_of_tx-rx_chains may refer to a number of transmit-receive chains to be switched off. The parameter number_of_tx-rx_chains may be an integer type parameter, having values from 1-8, of 3 bits. Furthermore, the parameter number_of_DL_slots may refer to a number of downlink slots to be disabled. The parameter number_of_DL_slots may be an integer type parameter, having values from 1-6, of 3 bits. The parameter start_slot may refer to a slot number from which the distributed unit 106 may have to disable for scheduling. The start_slot parameter may be an integer type parameter, having values from 0-6, of 3 bits. Further, the parameter PRBs_per_symbol may refer to a maximum number of PRBs per each symbol. The PRBs_per_symbol parameter may be an integer type parameter, having values from 0-273, of 9 bits. It may be noted that these set of parameters may be different for different power consumption policies. Based on identification of a new power consumption policy, the radio unit 104 and/or the distributed unit 106 may update these set of parameters in accordance with the newly identified power consumption policy.

Therefore, in accordance with embodiments of the present disclosure, the radio unit 104 may determine a low traffic state of the radio unit 104 and identify a power consumption policy from a plurality of power consumption policies for the radio unit 104 to enter a low power state. Further, the radio unit 104 may determine the set of parameters corresponding to the identified power consumption policy, and send these set of parameters to the distributed unit 106, as described herein above. In response, the distributed unit 106 may acknowledge the transition of the radio unit 104 from a normal state to the low power state, and send the information to upper layers for scheduling, for example, to a radio resource management (RRM) scheduler (e.g., 116). It may be appreciated that the normal state of the radio unit 104 may be any other state other than the low power state. For example, the normal state may include an active state of the radio unit 104, such that in the active state, all the PAs in the radio unit 104 may be enabled, the radio unit 104 may be running with full PRB utilization, and all the slots may be active. In an embodiment, the distributed unit 106 may send a time instance or an offset time at which the radio unit 104 may switch to the identified power consumption policy. The radio unit 104 may switch into the low power state by applying the identified power consumption policy at the time instance communicated by the distributed unit 106 and/or after completion of the offset time. It may be appreciated that since the radio unit 104 and the distributed unit 106 may be remotely connected entities, there might be a delay associated with receiving the offset time from the distributed unit 106. In order to incorporate the delay for synchronization, the distributed unit 106 may utilize a sub-frame number. For example, the distributed unit 106 may communicate a sub-frame number that may depict the effect of power consumption policy in the distributed unit 106 from that sub-frame number onwards. Accordingly, the radio unit 104 may apply the power consumption policy from that sub-frame number onwards to account for any delay associated with the exchange of information between the radio unit 104 and the distributed unit 106.

FIG. 3 illustrates an exemplary representation 300 of scheduling by an RRM scheduler, in accordance with embodiments of the present disclosure.

Referring to FIG. 3, an RRM scheduler 302 may take inputs, as depicted, and schedule resources according to priority of users. It may be appreciated that the RRM scheduler 302 may be similar to the radio resource scheduler 116 of FIG. 1B in its functionality. In an embodiment, the RRM scheduler 302 may take channel state information (CSI) measurements, buffer status report, Quality of Service (QOS) requirement, scheduling request, or the like, to schedule resources in time domain and frequency domain. Using all these inputs or parameters, the RRM scheduler 302 may calculate a performance metric for each user, and use it to schedule RBs. In an embodiment, the RRM scheduler 302 may form a linked list for each user through the allocated PRBs. It may be noted that the RRM scheduler 302 may not have any downlink symbols in special slot.

In accordance with embodiments of the present disclosure, as discussed above, a distributed unit (e.g., 106) may send the set of parameters for energy saving to the upper layers for scheduling, i.e., to the RRM scheduler 302. The RRM scheduler 302 may need time to switch from a normal scheduling scheme (i.e., a first scheduling scheme) to a new scheduling scheme (i.e., a second scheduling scheme) corresponding to the low power state of a radio unit (e.g., 104). This time may be referred as the offset time, i.e., the time taken by the RRM scheduler 302 to switch from the normal scheduling scheme to the new scheduling scheme, and therefore, the radio unit 104 may switch to the low power state after completion of the offset time.

In an embodiment, if the set of parameters include PRB reduction parameters for the RRM scheduler 302, then the RRM scheduler 302 may have to allocate the PRBs, as defined in the set of parameters received from the radio unit 104 and/or the distributed unit 106. In another embodiment, if slot reduction is to be performed by the radio unit 104, then the RRM scheduler 302 may not schedule in the excluded time slots.

FIG. 4 illustrates an exemplary representation 400 of a call flow from a radio unit to an RRM scheduler in a distributed unit, in accordance with embodiments of the present disclosure.

Referring to FIG. 4, a radio unit 104 may include a radio unit manager 402 and other radio unit components 404, as appropriate, and a distributed unit 106 may include an RRM scheduler 302 and other distributed unit components 406. Based on receiving a set of energy saving parameters from the radio unit 104, the distributed unit 106 may have information related to a power consumption policy identified for the radio unit 104 to enter a low power state. In an embodiment, the radio unit 104 or as such the radio unit manager 402 may send the information related to the low power state, i.e., the set of parameters to the RRM scheduler 302 as a NETCONF client. Alternatively, the distributed unit 106 may share this information with the RRM scheduler 302 in response to receiving the set of parameters from the radio unit 104 or the radio unit manager 402. Further, the RRM scheduler 302 may determine an offset time for changing a configuration from a normal scheduling scheme to a new scheduling scheme corresponding to the identified power consumption policy to be applied at the radio unit 104. The RRM scheduler 302 may send the offset time to the distributed unit 106, which may further send the offset time to the radio unit 104. Therefore, the radio unit 104 may apply the power consumption policy to enter the low power state on completion of the offset time. As discussed herein, the RRM scheduler 302 may share a sub-frame number from which the distributed unit 106 may apply the new scheduling scheme corresponding to the power consumption policy, and the radio unit 104 may switch to the low power state from the indicated sub-frame number to avoid any delay in synchronization between the radio unit 104 and the distributed unit 106.

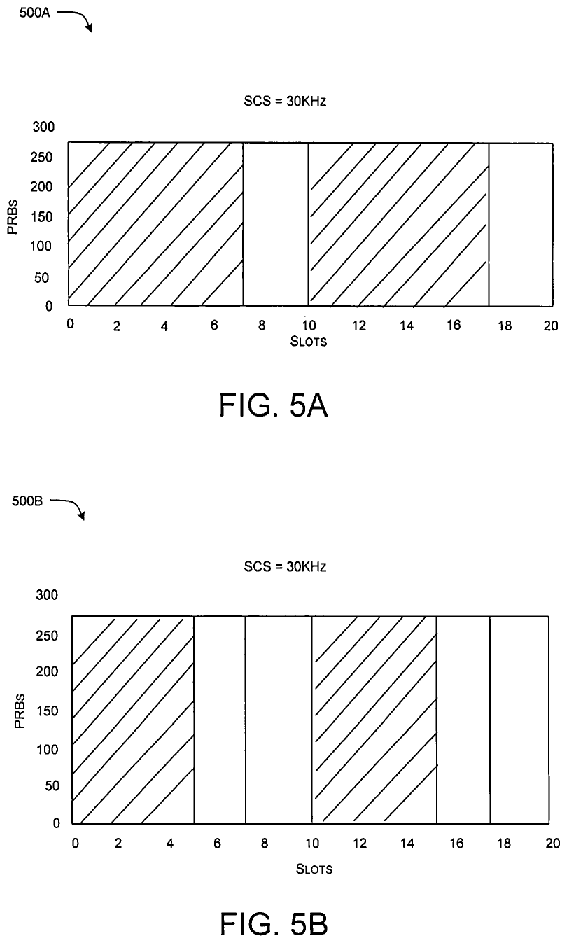

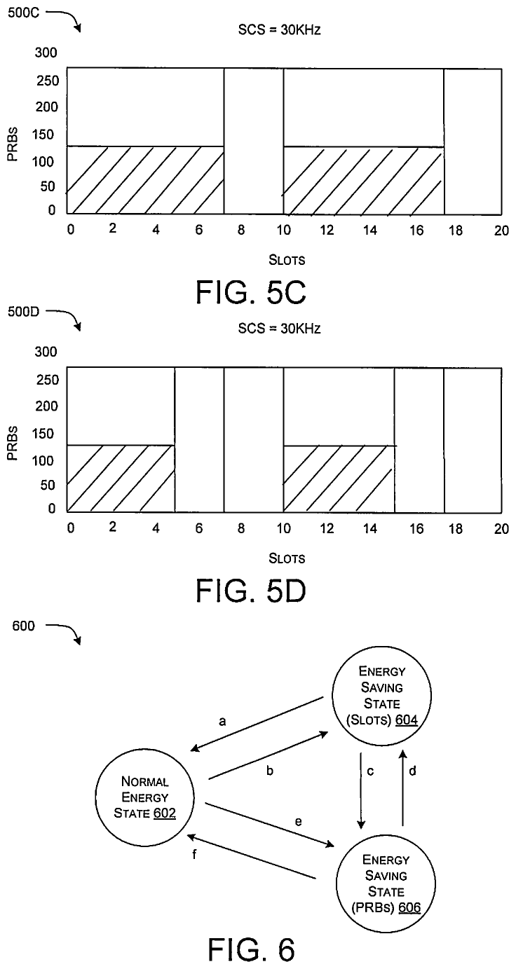

FIGS. 5A-5D illustrate exemplary representations (500A, 500B, 500C, 500D) of RRM scheduler resource grids, in accordance with embodiments of the present disclosure.

In particular, FIG. 5A illustrates an example resource grid 500A for a normal state (i.e., normal/first scheduling scheme) in which all 7 downlink slots are filled and all 273 PRBs are used. As depicted, in an example embodiment, the subcarrier spacing (SCS) has been considered as 30 kHz, where 0-7 slots are downlink slots, 8-10 slots are uplink slots, and there may be guard period or idle period between the uplink slots and the downlink slots. It may be noted that the SCS may be variable such that energy saving schemes may be applied in a similar manner, as discussed herein. Further, FIG. 5B illustrates an example resource grid 500B for a slot reduction scheme (i.e., one of the new scheduling schemes) in which 2 downlink slots out of total 7 downlink slots are not scheduled. Furthermore, FIG. 5C illustrates an example resource grid 500C for a PRB reduction scheme (i.e., one of the new scheduling schemes) in which half of the total 273 PRBs are scheduled. In some embodiments, based on U-plane utilization, the radio unit 104 may identify a number of PRBs to be scheduled. Additionally, FIG. 5D illustrates an example resource grid 500D for a combination of the above scheduling schemes referred in FIGS. 5B and 5C, i.e., slot reduction scheme and PRB reduction scheme, such that the radio unit 104 may determine a number of slots to be reduced along with a number of PRBs to be scheduled. Therefore, in order to change a configuration from the normal scheduling scheme to the new scheduling scheme, an RRM scheduler (e.g., 302) may determine an offset time and communicate the offset time to a radio unit (e.g., 104) to indicate that the radio unit 104 may switch to the low power state on completion of the offset time, because that is the time that the RRM scheduler 302 may take to switch the configuration for scheduling resources.

FIG. 6 illustrates an exemplary representation 600 of a state transition diagram for a radio unit in M-plane message based communication, in accordance with embodiments of the present disclosure.

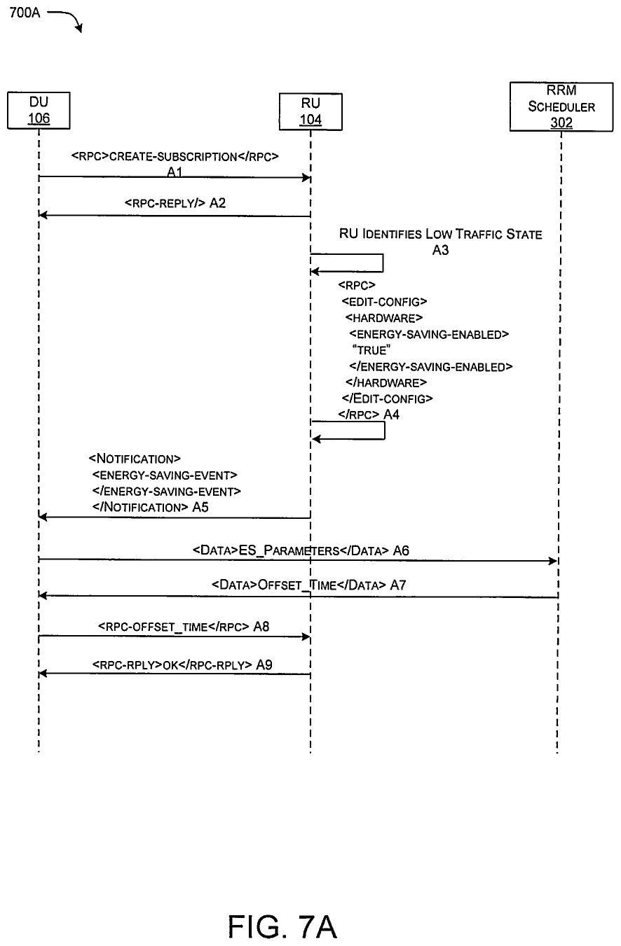

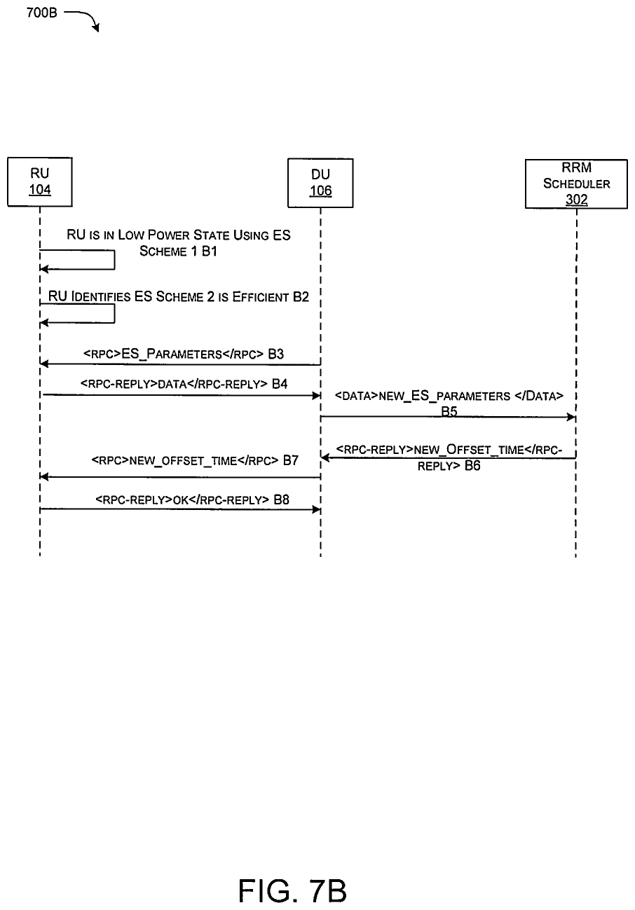

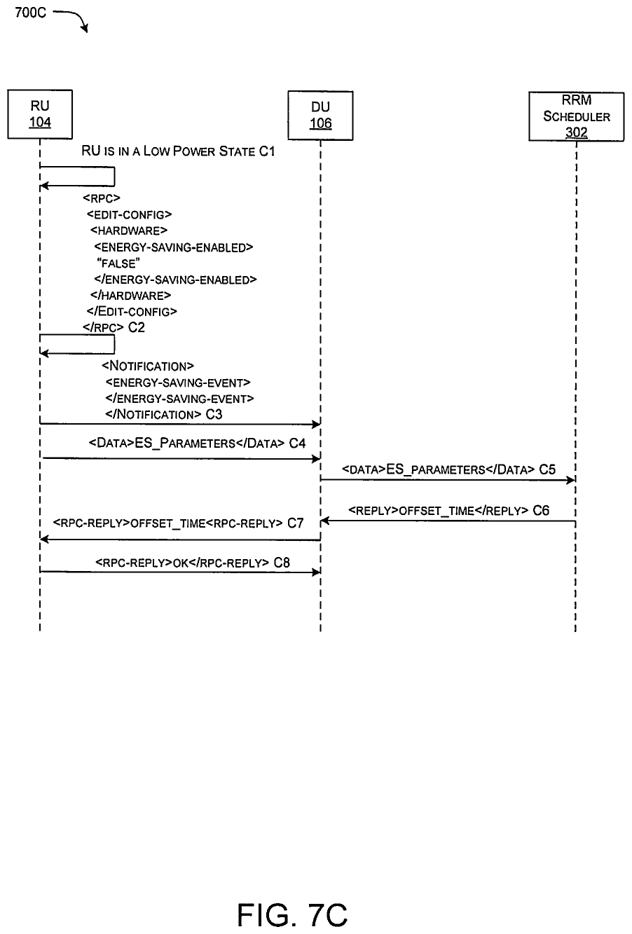

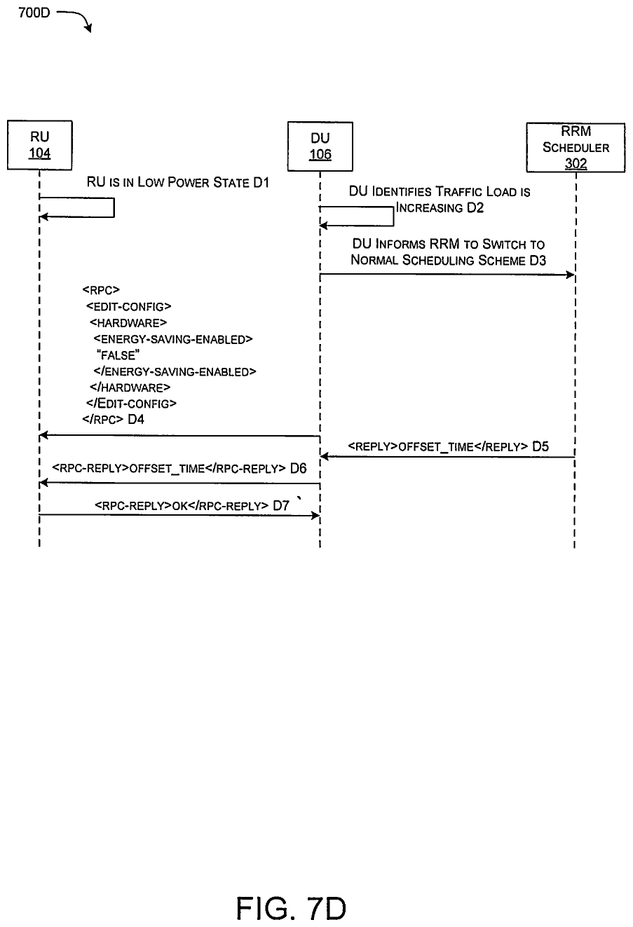

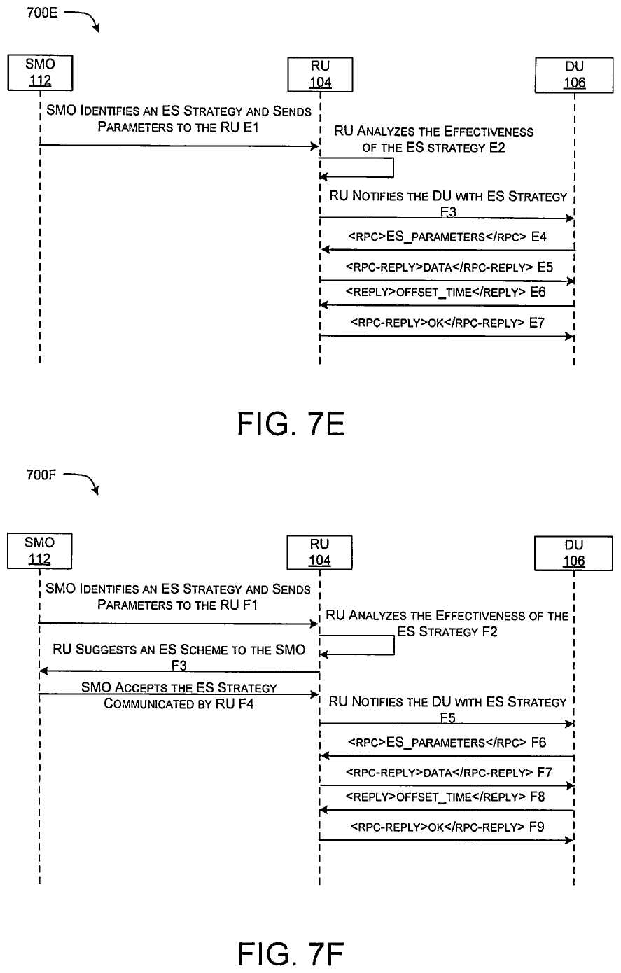

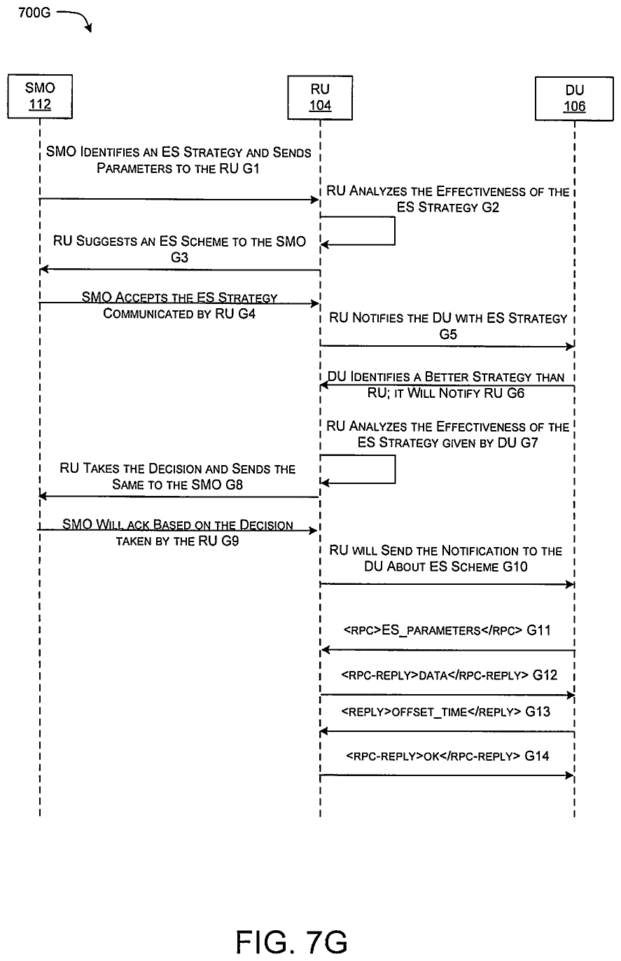

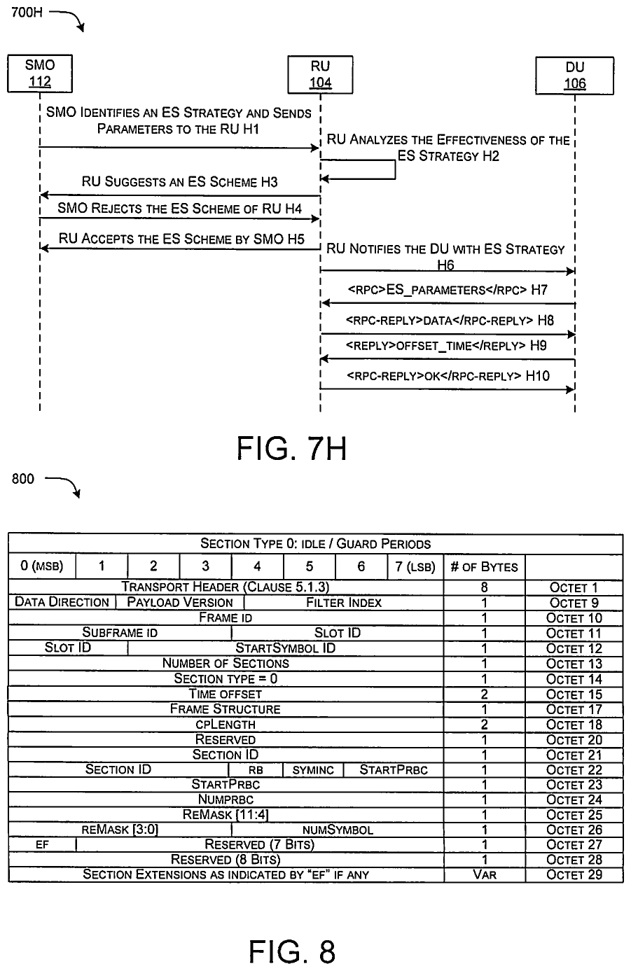

Referring to FIG. 6, a radio unit (e.g., 104) may switch from a normal state 602 to a slot reduction energy saving state 604, and vice versa. In another embodiment, the radio unit 104 may switch from the normal state 604 to a PRB reduction energy saving state 606, and vice versa. In another embodiment, the radio unit 104 may switch from the slot reduction energy saving state 604 to the PRB reduction energy saving state 606, and vice versa. In another embodiment, the radio unit 104 may switch to a low power state based on applying a combination of the slot reduction energy saving state 604 and the PRB reduction energy saving state 606. For example, the radio unit 104 may switch from any of the normal state 602, the slot reduction energy saving state 604, and the PRB reduction energy saving state 606 to the combination of the slot reduction energy saving state 604 and the PRB reduction energy saving state 606. This will be explained in detail with reference to FIGS. 7A-7H.

FIG. 7A illustrates an exemplary sequence flow diagram 700A for energy saving state activation for a radio unit, in accordance with embodiments of the present disclosure.

In an embodiment, a management and orchestration unit (e.g., 112) may determine a low traffic state for a radio unit 104, and inform the radio unit 104 to switch to a low power state (or, an energy saving state). Both ‘b’ and ‘e’ transitions of FIG. 6 may follow the sequence flow as depicted in FIG. 7A.

Referring to FIG. 7A, at steps A1 and A2, a connection may be established between the radio unit 104 and a distributed unit 106. At step A3, the radio unit 104 may determine the low traffic state. In an embodiment, the radio unit 104 may receive an indication of the low traffic state from the management and orchestration unit 112. In an embodiment, the low traffic state of the radio unit 104 may be determined based on a pre-defined threshold for monitored downlink traffic for a pre-configured time period.

Further, at step A4, the radio unit 104 may determine a power consumption policy from a plurality of power consumption policies to enter a low power state based on the low traffic state. In an embodiment, at step A4, the radio unit 104 may determine a set of energy saving parameters corresponding to the power consumption policy. For example, the set of energy saving parameters for M-plane message based communication may include, but not limited to, RU_ID, Energy Saving (ES), ES_type, predicted_data_rate, number_tx_rx_chains, number_of_DL_slots, start_slot, PRBs_per_symbol, and the like. The Energy Saving (ES) parameter may be enabled or disabled. The number_tx_rx_chains parameter may refer to a number of transmit-receive chains to be switched off, and the number_of_DL_slots parameter may refer to a number of downlink slots to be disabled. In some embodiments, the number_tx_rx_chains parameter may refer to a number of transmit-receive chains to be turned on, and the number_of_DL_slots parameter may refer to a number of downlink slots to be enabled.

Referring to FIG. 7A, at step A5, the radio unit 104 may communicate the determined power consumption policy and the set of parameters to the distributed unit 106 via M-plane. At step A6, the distributed unit 106 may send the set of parameters to an RRM scheduler 302 in the distributed unit 106.

Based on the set of parameters, the RRM scheduler 302 may determine an offset time to change a configuration from a normal scheduling scheme to a new scheduling scheme, as discussed above with reference to FIGS. 5A-5D, corresponding to the determined power consumption policy for the radio unit 104. At step A7, the RRM scheduler 302 may send the offset time to the distributed unit 106. Accordingly, at step A8, the distributed unit 106 may send the offset time to the radio unit 104. The offset time may indicate the radio unit 104 to apply the determined power consumption policy on completion of the offset time received from the distributed unit 106, because that is the time that the RRM scheduler 302 may take to change the configuration from the normal scheduling scheme to the new scheduling scheme based on the determined power consumption policy, i.e., slot reduction energy saving scheme or PRB reduction energy saving scheme, or the like. Further, at step A9, the radio unit 104 may send an acknowledgement for the offset time to the distributed unit 106.

FIG. 7B illustrates an exemplary sequence flow diagram 700B for modifying an existing energy saving state, in accordance with embodiments of the present disclosure.

In an embodiment, if a radio unit 104 identifies that a current power consumption policy is less efficient than another type of power consumption policy, then the radio unit 104 may send a message to a distributed unit 106 to update new energy saving state with new set of parameters. Both ‘c’ and ‘d’ transitions of FIG. 6 may follow the sequence flow as depicted in FIG. 7B.

Referring to FIG. 7B, at step B1, the radio unit 104 is in a low power state using a first power consumption policy. It may be appreciated that the first power consumption policy may include any power consumption policy, and the term “first” has been used only for illustrative purposes and for the sake of clarity and differentiation between different power consumption policies.

At step B2, the radio unit 104 may identify another power consumption policy, for example, a second power consumption policy that may be more efficient as compared to the first power consumption policy. In an embodiment, the radio unit 104 may determine the second power consumption policy based on the monitored downlink traffic at the radio unit 104 at a particular time instance, for example, a second time instance, which may be further to a first-time instance at which the radio unit 104 may have identified the first power consumption policy. Further, the radio unit 104 may analyze the power consumption policies based on a power saving potential associated with the power consumption policies. Based on the analysis, the radio unit 104 may determine that the second power consumption policy may be more efficient as compared to the first power consumption policy.

Further, at step B3, the radio unit 104 may receive a remote procedure call (RPC) from the distributed unit 106 to get a set of parameters corresponding to the determined power consumption policy. At step B4, the radio unit 104 may update the set of parameters based on the determined second power consumption policy, and send the updated set of parameters to the distributed unit 106. In another embodiment, the radio unit 104 may communicate the second power consumption policy to the distributed unit 106, and the distributed unit 106 may update the set of parameters based on the second power consumption policy. The distributed unit 106 may update the set of parameters in its local repository based on resource availability of the radio unit 104.

At step B5, the distributed unit 106 may send the updated set of parameters to RRM scheduler 302. Based on the updated set of parameters, the RRM scheduler 302 may update the offset time to change a configuration of a scheduling scheme based on the second power consumption policy, and send the updated offset time to the distributed unit 106 at step B6.

Referring to FIG. 7B, at step B7, the distributed unit 106 may send the updated offset time to the radio unit 104 for the radio unit 104 to apply the updated (e.g., second) power consumption policy on completion of the updated offset time to avoid any loss in data or packet drop. At step B8, the radio unit 104 may send an acknowledgement for the updated offset time to the distributed unit 106.

FIG. 7C illustrates an exemplary sequence flow diagram 700C for energy saving state deactivation for a radio unit, in accordance with embodiments of the present disclosure.

In an embodiment, if a radio unit 104 determines to switch from a low power state to a normal state, as discussed herein, then the radio unit 104 may change an energy saving parameter (i.e., ES parameter) to false, and send it to a distributed unit 106. Both ‘a’ and ‘f’ transitions of FIG. 6 may follow the sequence flow as depicted in FIG. 7C. It may be noted that the normal state may refer to a state when all the PAs in the radio unit 104 may be enabled, the radio unit 104 may be running with full PRB utilization, and all the downlink slots may be active.

Referring to FIG. 7C, at step C1, the radio unit 104 is in a low power state. At step C2, the radio unit 104 may determine to switch from the low power state to the normal state based at least on monitored downlink traffic and/or predicted downlink traffic. In another embodiment, a management and orchestration unit (e.g., 112) may, based on the monitored downlink traffic and/or the predicted downlink traffic at the radio unit 104, send an indication to the radio unit 104 to switch from the low power state to the normal state. In another embodiment, the distributed unit 106 may predict that the traffic at the radio unit 104 may increase, and accordingly, send an indication to the radio unit 104 to switch from the low power state to the normal state. Accordingly, at step C2, the radio unit 104 may update the set of energy saving parameters to disable the energy saving scheme/parameter.

At steps C3 and C4, the radio unit 104 may communicate to the distributed unit 106 that the radio unit 104 is going to enter the normal state along with the updated set of parameters. Further, at step C5, the distributed unit 106 may send the updated set of parameters to an RRM scheduler 302. In an embodiment, the RRM scheduler 302 may determine an updated offset time to change a configuration from the energy saving scheduling scheme (with reference to FIGS. 5B-5D) to a normal scheduling scheme (i.e., FIG. 5A) based on the received set of updated parameters. At step C6, the RRM scheduler 302 may send the updated offset time to the distributed unit 106.

Further, at step C7, the distributed unit 106 may send the updated offset time to the radio unit 104 to switch from the low power state to the normal state on completion of the updated offset time. Accordingly, at step C8, the radio unit 104 may send an acknowledgement for the updated offset time to the distributed unit 106.

FIG. 7D illustrates an exemplary sequence flow diagram 700D for energy saving state deactivation from a distributed unit, in accordance with embodiments of the present disclosure.

In an embodiment, if a distributed unit 106 identifies that traffic at a radio unit 104 is going to increase, the distributed unit 106 may inform the radio unit 104 to switch from a low power state to a normal state.

Referring to FIG. 7D, at step D1, the radio unit 104 is in a low power state. At step D2, the distributed unit 106 identifies that traffic load is going to increase. In an embodiment, the distributed unit 106 may predict the downlink traffic at the radio unit 104, and based on the predicted downlink traffic at the radio unit 104, the distributed unit 106, at step D3, may inform an RRM scheduler 302 to switch from an energy saving scheduling scheme to a normal scheduling scheme. Similarly, at step D4, the distributed unit 106 may send a message to the radio unit 104 to switch from the low power state to the normal state.

Further, at step D5, the RRM scheduler 302 may determine an updated offset time to change a configuration of scheduling to the normal scheduling scheme, and send the updated offset time to the distributed unit 106. At step D6, the distributed unit 106 may send the updated offset time to the radio unit 104 to switch from the low power state to the normal state on completion of the updated offset time. Accordingly, at step D7, the radio unit 104 may send an acknowledgement for the updated offset time to the distributed unit 106.

FIG. 7E illustrates an exemplary sequence flow diagram 700E for conflict resolution between a radio unit, a distributed unit, and a management and orchestration unit, where the radio unit accepts a decision of the management and orchestration unit, in accordance with embodiments of the present disclosure.

In a hybrid mode of management, a radio unit 104 may receive energy saving messages either from a distributed unit 106 or a management and orchestration unit 112. In an embodiment, if the radio unit 104 receives an energy saving message from the management and orchestration unit 112, for example, slot reduction energy saving scheme, the radio unit 104 may analyse the effectiveness of the energy saving scheme, and intimate the management and orchestration unit 112 if the radio unit 104 may have an alternate energy saving scheme that is more efficient. In an embodiment, the radio unit 104 may analyze a power saving potential of the energy saving scheme, and suggest an alternate energy saving scheme. If the management and orchestration unit 112 agrees, then the decision taken by the radio unit 104 may be intimated to the distributed unit 106. In an embodiment, if the distributed unit 106 identifies a better energy saving scheme, the distributed unit 106 may intimate it to the radio unit 104. If the radio unit 104 accepts this strategy suggested by the distributed unit 106, then the radio unit 104 may notify the management and orchestration unit 112 that it has a better energy saving strategy, and hence, may implement it. The management and orchestration unit 112 may acknowledge the decision of the radio unit 104, and basis the acknowledgement, the radio unit 104 may implement the energy saving strategy. This will be further explained herein below with reference to FIGS. 7E-7H.

Referring to FIG. 7E, at step E1, the management and orchestration unit 112 (also referred as SMO herein) may determine a power consumption policy (or an energy saving strategy) for the radio unit 104. Accordingly, the management and orchestration unit 112 may send the identified power consumption policy to the radio unit 104. Further, at step E2, the radio unit 104 may analyze the effectiveness of the power consumption policy. In an embodiment, the radio unit 104 may analyze a power saving potential associated with the power consumption policy, and based on the power saving potential, the radio unit 104, at step E3, may notify the distributed unit 106 regarding the power consumption policy.

Referring to FIG. 7E, at step E4, the radio unit 104 may receive an RPC from the distributed unit 106 to get a set of parameters corresponding to the power consumption policy. At step E5, the radio unit 104 may update the set of parameters based on the determined power consumption policy, and send the set of parameters to the distributed unit 106.

Further, based on the set of parameters, the distributed unit 106, and as such, an RRM scheduler (e.g., 302) may determine an offset time for the radio unit 104. Accordingly, at step E6, the distributed unit 106 may send the offset time to the radio unit 104 to switch to a low power state by applying the power consumption policy on completion of the offset time. Thereafter, at step E7, the radio unit 104 may send an acknowledgement for the offset time to the distributed unit 106.

FIG. 7F illustrates an exemplary sequence flow diagram 700F for conflict resolution between a radio unit, a distributed unit, and a management and orchestration unit, wherein the radio unit suggests an alternate energy saving strategy to the management and orchestration unit, in accordance with embodiments of the present disclosure.

Referring to FIG. 7F, at step F1, a management and orchestration unit 112 may identify a power consumption policy (for example, a first power consumption policy) for a radio unit 104. It may be appreciated that the first power consumption policy may include any power consumption policy, and the term “first” has been used only for illustrative purposes and for the sake of clarity and differentiation between different power consumption policies.

The management and orchestration unit 112 may send the determined first power consumption policy to the radio unit 104. Further, at step F2, the radio unit 104 may analyze the effectiveness of the first power consumption policy. In an embodiment, the radio unit 104 may analyze a power saving potential associated with the first power consumption policy and a number of other power consumption policies (for example, second and third power consumption policies). Based on the power saving potential, the radio unit 104 may determine another power consumption policy (for example, a second power consumption policy) that may be more effective in saving power or energy than the first power consumption policy communicated by the management and orchestration unit 112. Accordingly, at step F3, the radio unit 104 may send the second power consumption policy to the management and orchestration unit 112.

Based on current and predicted downlink traffic at the radio unit 104, the management and orchestration unit 112, at step F4, may send a positive acknowledgment for the second power consumption policy to the radio unit 104. Accordingly, at step F5, the radio unit 104 may notify a distributed unit 106 regarding the second power consumption policy.

Referring to FIG. 7F, at step F6, the radio unit 104 may receive an RPC from the distributed unit 106 to get a set of parameters corresponding to the second power consumption policy. At step F7, the radio unit 104 may update the set of parameters based on the second power consumption policy, and send the updated set of parameters to the distributed unit 106.

Further, based on the updated set of parameters, the distributed unit 106, and as such, an RRM scheduler (e.g., 302) may determine an updated offset time for the radio unit 104. Accordingly, at step F8, the distributed unit 106 may send the updated offset time to the radio unit 104 to switch to the low power state by applying the second power consumption policy on completion of the updated offset time. Thereafter, at step F9, the radio unit 104 may send an acknowledgement for the updated offset time to the distributed unit 106.

FIG. 7G illustrates an exemplary sequence flow diagram 700G for conflict resolution between a radio unit, a distributed unit, and a management and orchestration unit, wherein the distributed unit suggests an alternate energy saving strategy to the radio unit, in accordance with embodiments of the present disclosure.

Referring to FIG. 7G, at step G1, a management and orchestration unit 112 may identify a power consumption policy (for example, a first power consumption policy) for a radio unit 104. It may be appreciated that the first power consumption policy may include any power consumption policy, and the term “first” has been used only for illustrative purposes and for the sake of clarity and differentiation between different power consumption policies.

The management and orchestration unit 112 may send the determined first power consumption policy to the radio unit 104. Further, at step G2, the radio unit 104 may analyze the effectiveness of the first power consumption policy. In an embodiment, the radio unit 104 may analyze a power saving potential associated with the first power consumption policy and a number of other power consumption policies. Based on the power saving potential, the radio unit 104 may determine another power consumption policy (for example, a second power consumption policy) that may be more effective in saving power or energy than the first power consumption policy communicated by the management and orchestration unit 112. Accordingly, at step G3, the radio unit 104 may send the second power consumption policy to the management and orchestration unit 112.

Based on current and predicted downlink traffic at the radio unit 104, the management and orchestration unit 112, at step G4, may send a positive acknowledgment for the second power consumption policy to the radio unit 104. Accordingly, at step G5, the radio unit 104 may notify a distributed unit 106 regarding the second power consumption policy.

Referring to FIG. 7G, based on the current and predicted downlink traffic at the radio unit 104, the distributed unit 106 may determine another power consumption policy (for example, a third power consumption policy) for the radio unit 104. Accordingly, at step G6, the distributed unit 106 may communicate the determined third power consumption policy to the radio unit 104. At step G7, the radio unit 104 may analyze the effectiveness of the third power consumption policy as compared to other power consumption polices, e.g., first power consumption policy, second power consumption policy, or a combination of the first power consumption policy and the second power consumption policy. Accordingly, the radio unit 104 may decide and send the decision, for example, regarding the third power consumption policy to the management and orchestration unit 112 at step G8.

In an embodiment, at step G9, the management and orchestration unit 112 may send a positive acknowledgement for the decision, i.e., the third power consumption policy as an example, taken by the radio unit 104. Likewise, at step G10, the radio unit 104 may communicate the decision of the third power consumption policy to the distributed unit 106. Accordingly, at step G11, the radio unit 104 may receive an RPC call from the distributed unit 106 to get a set of parameters corresponding to the third power consumption policy. At step G12, the radio unit 104 may update the set of parameters based on the third power consumption policy, and send the updated set of parameters to the distributed unit 106.

Further, based on the updated set of parameters, the distributed unit 106, and as such, an RRM scheduler (e.g., 302) may determine an updated offset time for the radio unit 104. Accordingly, at step G13, the distributed unit 106 may send the updated offset time to the radio unit 104 to switch to the low power state by applying the third power consumption policy on completion of the updated offset time. Thereafter, at step G14, the radio unit 104 may send an acknowledgement for the updated offset time to the distributed unit 106.

FIG. 7H illustrates an exemplary sequence flow diagram 700H for conflict resolution between a radio unit, a distributed unit, and a management and orchestration unit, wherein the management and orchestration unit rejects an energy saving strategy suggested by the radio unit, in accordance with embodiments of the present disclosure.

Referring to FIG. 7H, at step H1, a management and orchestration unit 112 may identify a power consumption policy (for example, a first power consumption policy) for a radio unit 104. It may be appreciated that the first power consumption policy may include any power consumption policy, and the term “first” has been used only for illustrative purposes and for the sake of clarity and differentiation between different power consumption policies.

Accordingly, the management and orchestration unit 112 may send the determined first power consumption policy to the radio unit 104. Further, at step H2, the radio unit 104 may analyze the effectiveness of the first power consumption policy. In an embodiment, the radio unit 104 may analyze a power saving potential associated with the first power consumption policy and a number of other power consumption policies. Based on the power saving potential, the radio unit 104 may determine another power consumption policy (for example, a second power consumption policy) that may be more effective in saving power or energy than the first power consumption policy communicated by the management and orchestration unit 112. Accordingly, at step H3, the radio unit 104 may send the second power consumption policy to the management and orchestration unit 112.

Based on current and predicted downlink traffic at the radio unit 104, the management and orchestration unit 112, at step H4, may send a negative acknowledgment for the second power consumption policy to the radio unit 104. Accordingly, at step H5, the radio unit 104 may accept the first power consumption policy suggested by the management and orchestration unit 112 (at step H1). Further, at step H6, the radio unit 104 may notify a distributed unit 106 regarding the first power consumption policy.

Referring to FIG. 7H, at step H7, the radio unit 104 may receive an RPC call from the distributed unit 106 to get a set of parameters corresponding to the first power consumption policy. At step H8, the radio unit 104 may update the set of parameters based on the first power consumption policy, and send the updated set of parameters to the distributed unit 106.

Further, based on the updated set of parameters, the distributed unit 106, and as such, an RRM scheduler 302 may determine an offset time for the radio unit 104. Accordingly, at step H9, the distributed unit 106 may send the updated offset time to the radio unit 104 to switch to the low power state by applying the first power consumption policy on completion of the offset time. Thereafter, at step H10, the radio unit 104 may send an acknowledgement for the offset time to the distributed unit 106.

### C-Plane Message Based Communication

In accordance with embodiments of the present disclosure, C-plane messages may be transferred between a radio unit (e.g., 104) and a distributed unit (e.g., 106) for data associated control information for user data processing. In a C-plane message, control information for a set of symbols may be exchanged. Using this information, user-plane (U-plane) data may be received for those symbols. It may be noted that C-plane messages may be transferred in C-plane packets. Every packet may consist of two layers, i.e., transport layer and application layer. The transport layer may consist of eCPRI header information, common header information, data direction, payload version, filter index, frame identifier (ID), sub-frame ID, slot ID, start symbol ID, number of sections, and section type. Further, the application layer may consist of section ID, resource block, symbol number increment command field (symInc), starting PRB of data section description field (startPrbc), number of contiguous PRBs per data section description field (numPrbc), resource element mask field (reMask), number of symbol fields (numSymbol), extension flag field (ef), and reserved for future use field.

In an embodiment, the radio unit 104 may use Section type 0 from O-RAN control, user, and synchronization plane specification v11.00 for energy saving information. A person of ordinary skill in the art may understand that section type 0 message may indicate to the radio unit 104 (or, O-RU) that certain resource blocks or symbols may not be used (idle periods, guard periods). Likewise, there may be no associated U-plane messages containing IQ data for this section type. The purpose may be to inform the radio unit 104 that transmissions may be halted during the specified idle interval, for example, power savings or to provide an interval for calibration.

FIG. 8 illustrates a message format 800 for section type 0 in C-plane message based communication, in accordance with embodiments of the present disclosure.

As depicted in FIG. 8, section extensions may be indicated by extension flag, if any. For example, the extension flag indicator may be enabled if there are extension fields. Else, the extension flag indicator may be disabled.

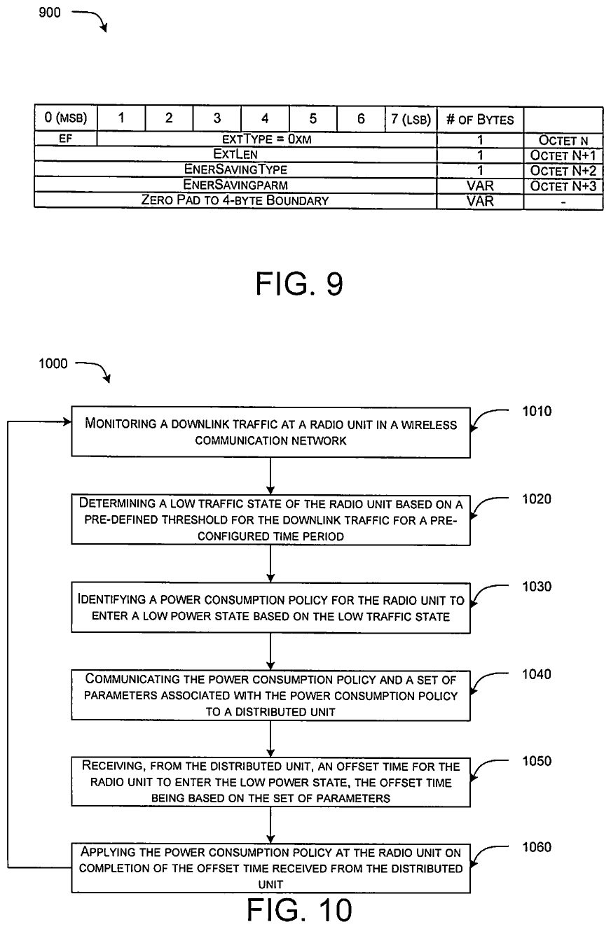

FIG. 9 illustrates a new section extension for section type 0 in C-plane message based communication for energy saving, in accordance with embodiments of the present disclosure.

In an embodiment, if an extension flag indicator in the section type 0 message is enabled, then the extension fields may include a set of parameters for C-plane message based communication between a radio unit (e.g., 104) and a distributed unit (e.g., 106), as depicted in FIG. 9. In an embodiment, extension type may give an extension type number to which the parameter may belong in the standards-defined extension types. As per O-RAN control, user, and synchronization plane specification v11.00, 23 extension types are defined. Therefore, the extension number ‘m’ in the extension type may have any value from 24 to 127. Further, the extension number ‘m’ may be reserved for energy saving extension type. The length of this parameter/field may be 7 bits.

Further, extension flag may indicate whether another section extension data is present or not, and the length of this field may be 1 bit. In an embodiment, if the extension flag is 1, then energy saving state is enabled, i.e., extension fields are there. In another embodiment, if the extension flag is 0, then energy saving state if disabled, i.e., extension fields are not there. Furthermore, extension length may provide a length of the section extension in 32 bits or 4 byte words.

In an embodiment, energy saving type may give the type of energy saving scheme used, and the length of the field may be 4 bits. In an embodiment, the energy saving type may have values from 0000-1111b. For example, there may be 3 types of energy saving schemes, as discussed herein. If the energy saving type is 0000b, it may refer to slot reduction energy saving scheme. If the energy saving type is 0001b, it may refer to PRB reduction energy saving scheme. If the energy saving type is 0010b, it may refer to a combination of slot reduction and PRB reduction energy saving schemes. The below table 3 shows the energy saving type and their corresponding values, in an example embodiment.

TABLE 3

| Energy Saving Type | Value of Energy Saving Type |
|---|---|
| 0000-1111b | Example 1: energysavingtype = 0000b means slot reduction. |
| | Example 2: energysavingtype = 0001b means PRB reduction. |
| | Example 3: energysavingtype = 0010b means both slot reduction and |
| | PRB reduction. |

Referring to FIG. 9, the new section extension may include energy saving parameters or set of parameters for C-plane message based communication such as, but not limited to, tx-rx, number of PRBs per symbol, start slot, number of slots, and the like. In an embodiment, the tx-rx may refer to a number of transmit-receive chains powered off, and the length may be 4 bits. The parameter size may be 1 octet. The below table 4 depicts the same.

TABLE 4

| | | | | | | | | Number |
|---|---|---|---|---|---|---|---|---|
| 0 | | | | | | | 7 | of |
| (msb) | 1 | 2 | 3 | 4 | 5 | 6 | (lsb) | octets |

| | | | |
|---|---|---|---|
| Energy Saving Type | tx_rx | 1 | Octet 1 |

Further, the number of PRBs per symbol may refer to a number of PRBs which may be allocated per each symbol, and the parameter size may be 1 octet. Furthermore, the start slot may refer to a slot number from which scheduling may have to be disabled. Additionally, the number of slots may refer to a number of downlink slots which are to be disabled, and the parameter size for the start slot and the number of slots may be 1 octet. In an exemplary embodiment, if the energy saving type is 0010b, i.e., combination of both power consumption policies, then the set of energy saving parameters may include the number of PRBs per symbol, the start slot, and the number of slots, and accordingly, the parameter size may be 2 octets. The below table 5 depicts the same.

TABLE 5

| Energy | | | | | | | | | |
|---|---|---|---|---|---|---|---|---|---|
| Saving | 0 | | | | | | | 7 | Parameter |
| Type | (msb) | 1 | 2 | 3 | 4 | 5 | 6 | (lsb) | size |
| 0000b = | Start slot | | | | Number of slots | | | | 1 Octet |
| Slot | | | | | | | | | |
| reduction | | | | | | | | | |
| 0001b = | Number of PRBs per symbol | | | | | | | | 1 Octet |
| PRB | | | | | | | | | |
| reduction | | | | | | | | | |
| 0010b = | Both above parameters are required | | | | | | | | 2 Octet |
| both | | | | | | | | | |

Therefore, in accordance with embodiments of the present disclosure, the communication between the radio unit 104 and the distributed unit 106 and/or a management and orchestration unit (e.g., 112) may be via M-plane message based communication or C-plane message based communication. Based on the current downlink traffic conditions as well as predicted traffic conditions, an appropriate mode of communication may be selected from among the M-plane and C-plane message based communication to facilitate efficient coordination between control elements in the network. In an embodiment, if the traffic variation is within a pre-defined limit, the power consumption policy may be applied at the radio unit 104 for a longer time duration (i.e., static for some time extent). During this scenario, M-plane message based communication may be more efficient, and therefore, communication between the radio unit 104 and the distributed unit 106 may be via the M-plane message based communication.

In another embodiment, if the traffic variation is outside the pre-defined limit, the power consumption policy may be applied at the radio unit 104 for a shorter time duration as compared to the above scenario (i.e., dynamic for some time extent). During this scenario, C-plane message based communication may be more efficient as its periodicity is less, and therefore, communication between the radio unit 104 and the distributed unit 106 may be via the C-plane message based communication.

In an embodiment, during peak hours, a symbol level power control mechanism may be enabled, and selection between the appropriate modes of communication may be done based on the symbol level power control mechanism for energy efficiency. For example, if the symbol level power control mechanism is enabled, the communication between the radio unit 104 and the distributed unit 106 may be via the C-plane message based communication for exchanging energy saving information. If the symbol level power control mechanism is disabled, the communication between the radio unit 104 and the distributed unit 106 may be via the M-plane message based communication for exchanging energy saving information. In general, for static power control mechanism, messages related to energy saving information may be communicated via M-plane message based communication. For performing fine grained power control mechanism, C-plane message based communication may be used for exchanging energy saving information between the radio unit 104 and the distributed unit 106. In some embodiments, in the M-plane message based communication, the radio unit 104 may keep a flag for dynamic symbol level power control. If the flag is enabled by the distributed unit 106, the C-plane message based communication may be initiated for exchanging the energy saving information. As the periodicity of the C-plane message based communication may be less than the M-plane message based communication, for dynamic energy control, utilizing C-plane message based communication may be appropriate.

FIG. 10 illustrates an exemplary flow chart 1000 of a method for managing communication in a wireless communication network, in accordance with embodiments of the present disclosure. It may be appreciated that the method 1000 may be performed at a radio unit (e.g., 104).

Referring to FIG. 10, at step 1010, the method 1000 may include monitoring a downlink traffic at the radio unit 104 in a wireless communication network at a particular time instance, i.e., first-time instance. At step 1020, the method 1000 may include determining a low traffic state of the radio unit 104 based on a pre-defined threshold for the monitored downlink traffic for a pre-configured time period.

Further, at step 1030, the method 1000 may include identifying a power consumption policy from a plurality of power consumption policies for the radio unit 104 to enter a low power state based on the determined low traffic state. In an embodiment, the method 1000 may include determining the power consumption policy by the radio unit 104. In another embodiment, the method 1000 may include receiving, from a management unit (e.g., 112), a message indicating the power consumption policy for the radio unit 104 based on the low traffic state of the radio unit 104. In such an embodiment, the radio unit 104 may analyze a power saving potential associated with the power consumption policy. Based on the power saving potential, the radio unit 104 may send an acknowledgement for the power consumption policy to the management unit 112 based on the power saving potential associated with the power consumption policy. In an embodiment, the radio unit 104 may determine another power consumption policy from the plurality of power consumption policies for the radio unit 104 based on the power saving potential associated with the power consumption policy (i.e., received from the management unit 112) and the another power consumption policy, and communicate the determined another power consumption policy to the management unit 112. In an embodiment, the radio unit 104 may receive an acknowledgment from the management unit 112 for the another power consumption policy. The acknowledgement may include a positive acknowledgement or a negative acknowledgement. In case of a positive acknowledgement, the radio unit 104 may decide to apply the another power consumption policy. In case of a negative acknowledgement, the radio unit 104 may decide to apply the power consumption policy suggested by the management unit 112.

Referring to FIG. 10, at step 1040, the method 1000 may include communicating the determined power consumption policy and a set of parameters associated with the determined power consumption policy to a distributed unit (e.g., 106) in the wireless communication network. Further, at step 1050, the method 1000 may include receiving, from the distributed unit 106, an offset time for the radio unit 104 to enter the low power state, the offset time being based on the set of parameters associated with the determined power consumption policy. Furthermore, at step 1060, the method 1000 may include applying the power consumption policy at the radio unit 104 on completion of the offset time received from the distributed unit 106. It may be noted that the method 100 may continue to monitor the downlink traffic at the radio unit 104 (based on step 1010).

As discussed herein, the communication between the radio unit 104 and the distributed unit 106 and/or the management unit 112 may be via one of M-plane message based communication or C-plane message based communication. In an embodiment, the set of parameters for the M-plane message based communication may include, but not be limited to, an identifier of the radio unit, i.e. RU_ID, a bit corresponding to the low power state of the radio unit, i.e. Energy Saving (ES), a type of power consumption policy, i.e., ES_type, a predicted traffic rate, i.e. predicted_data_rate, a number of transmit/receive chains to be disabled, i.e., number_of_tx-rx_chains, a number of downlink slots to be disabled, i.e., number_of_DL_slots, a start slot number, i.e., start_slot, and a maximum number of PRBs per each symbol, i.e. PRBs_per_symbol.

In another embodiment, the C-plane message based communication may include an exchange of C-plane packets between the radio unit 104 and the distributed unit 106 and/or the management unit 112. Each C-plane packet may consist of an extension flag indicator (ef). If the extension flag indicator is enabled, it may indicate that section extension fields exist. In such a scenario, the extension fields may include, but not be limited to, extension type, extension length, energy saving type, and the set of energy saving parameters. In an embodiment, the set of parameters for the C-plane message based communication may include, but not be limited to, number of PRBs per symbol, start slot, and number of slots.

It may be appreciated that the steps shown in FIG. 10 are merely illustrative. Other suitable steps may be used for the same, if desired. Moreover, the steps of the method 1000 may be performed in any order and may include additional steps.

The blocks of the flow diagram shown in FIG. 10 have been arranged in a generally sequential manner for ease of explanation; however, it is to be understood that this arrangement is merely exemplary, and it should be recognized that the processing associated with method 1000 may occur in a different order (for example, where at least some of the processing associated with the blocks is performed in parallel and/or in an event-driven manner). Further, it may be appreciated that the steps shown in FIG. 10 are merely illustrative. Other suitable steps may be used for the same, if desired. Moreover, the steps of the method 1000 may be performed in any order and may include additional steps.

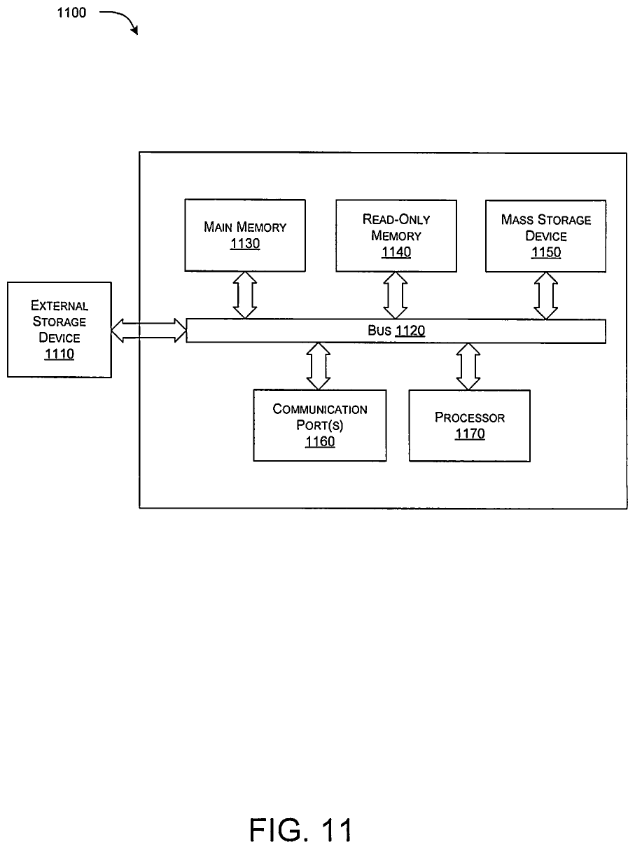

The methods and techniques described here may be implemented in digital electronic circuitry, field programmable gate array (FPGA), or with a programmable processor (for example, a special-purpose processor or a general-purpose processor such as a computer) firmware, software, or in combinations of them. Apparatus embodying these techniques may include appropriate input and output devices, FPGA, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system, explained in detail with reference to FIG. 11, including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as erasable programmable read-only memory (EPROM), and flash memory devices; magnetic disks such as internal hard disks and removable disks; and magneto-optical disks. Any of the foregoing may be supplemented by, or incorporated in, specially designed application-specific integrated circuits (ASICs).

In particular, FIG. 11 illustrates an exemplary computer system 1100 in which or with which embodiments of the present disclosure may be utilized. The computing system 1100 may be implemented as or within the radio unit 104 and/or the distributed unit 106 and/or the management unit 112 and/or any suitable network device described in accordance with embodiments of the present disclosure. As depicted in FIG. 11, the computer system 1100 may include an external storage device 1110, a bus 1120, a main memory 1130, a read-only memory 1140, a mass storage device 1150, communication port(s) 1160, and a processor 1170. A person skilled in the art will appreciate that the computer system 1100 may include more than one processor 1170 and communication ports 1160. The processor 1170 may include various modules associated with embodiments of the present disclosure. The communication port(s) 1160 may be any of an RS-232 port for use with a modem-based dialup connection, a 10/100 Ethernet port, a Gigabit or 10 Gigabit port using copper or fiber, a serial port, a parallel port, or other existing or future ports. The communication port(s) 1160 may be chosen depending on a network, such a Local Area Network (LAN), Wide Area Network (WAN), or any network to which the computer system 1100 connects.

In an embodiment, the main memory 1130 may be Random Access Memory (RAM), or any other dynamic storage device commonly known in the art. The read-only memory 1140 may be any static storage device(s) e.g., but not limited to, a Programmable Read Only Memory (PROM) chips for storing static information e.g., start-up or basic input output system (BIOS) instructions for the processor 1170. The mass storage device 1150 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus 1120 communicatively couples the processor 1170 with the other memory, storage, and communication blocks. The bus 1120 may be, e.g., a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor 1170 to the computer system 1100.

In another embodiment, operator and administrative interfaces, e.g., a display, keyboard, and a cursor control device, may also be coupled to the bus 620 to support direct operator interaction with the computer system 1100. Other operator and administrative interfaces may be provided through network connections connected through the communication port(s) 1160. Components described above are meant only to exemplify various possibilities. In no way should the aforementioned exemplary computer system 1100 limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure provides an efficient solution for synchronized coordination between control elements in a network architecture such as a radio unit, a distributed unit, and a management and orchestration unit.

The present disclosure optimizes power consumption without any performance degradation.

The present disclosure provides efficient coordination between the control elements for energy efficiency control originating from the radio unit.

I/We claim:

1. A method for managing communication in a wireless communication network, the method comprising:
monitoring, by a processor associated with a radio unit, a downlink traffic at the radio unit in the wireless communication network at a first time instance;
determining, by the processor, a low traffic state of the radio unit based on a pre-defined threshold for the monitored downlink traffic for a pre-configured time period;
identifying, by the processor, a power consumption policy from a plurality of power consumption policies for the radio unit to enter a low power state based on the determined low traffic state;
communicating, by the processor, the identified power consumption policy and a set of parameters associated with the identified power consumption policy to a distributed unit in the wireless communication network;
receiving, by the processor, from the distributed unit, an offset time for the radio unit to enter the low power state, the offset time being based on the set of parameters associated with the identified power consumption policy; and
applying, by the processor, the power consumption policy at the radio unit on completion of the offset time received from the distributed unit.

2. The method as claimed in claim 1, comprising:
determining, by the processor, another power consumption policy from the plurality of power consumption policies for the radio unit based on the monitored downlink traffic at a second time instance, the first time instance being prior to the second time instance;
sending, by the processor, a message to the distributed unit to update the set of parameters based on the determined another power consumption policy;
receiving, by the processor, from the distributed unit, an updated offset time for the radio unit to switch from the power consumption policy to the another power consumption policy, the updated offset time being based on the updated set of parameters associated with the determined another power consumption policy; and
applying, by the processor, the another power consumption policy at the radio unit on completion of the updated offset time received from the distributed unit.

3. The method as claimed in claim 1, comprising:
receiving, by the processor, from the distributed unit, a second offset time for the radio unit to switch from the low power state to a normal state based on a predicted downlink traffic at the radio unit; and
configuring, by the processor, the radio unit to enter the normal state on completion of the second offset time received from the distributed unit.

4. The method as claimed in claim 1, wherein identifying, by the processor, the power consumption policy comprises:
receiving, by the processor, from a management unit in the wireless communication network, a message indicating the power consumption policy for the radio unit based on the low traffic state of the radio unit; and
analyzing, by the processor, a power saving potential associated with the power consumption policy.

5. The method as claimed in claim 4, comprising:
sending, by the processor, an acknowledgement for the power consumption policy to the management unit based on the power saving potential associated with the power consumption policy.

6. The method as claimed in claim 4, comprising:
determining, by the processor, another power consumption policy from the plurality of power consumption policies for the radio unit based on the power saving potential associated with the power consumption policy and the another power consumption policy;
communicating, by the processor, the determined another power consumption policy to the management unit; and
receiving, by the processor, from the management unit, an acknowledgement for the another power consumption policy for the radio unit, wherein the acknowledgement comprises one of: a positive acknowledgement for the another power consumption policy, or a negative acknowledgement for the another power consumption policy, and wherein in case of the negative acknowledgment, the method comprises sending, by the processor, an acknowledgement for the power consumption policy to the management unit.

7. The method as claimed in claim 1, comprising:
in response to communicating the power consumption policy to the distributed unit, receiving, by the processor, from the distributed unit, an indication of another power consumption policy from the plurality of power consumption policies for the radio unit based on the monitored downlink traffic and a predicted downlink traffic;
analyzing, by the processor, a power saving potential associated with the power consumption policy and the another power consumption policy;
communicating, by the processor, the another power consumption policy to a management unit in the wireless communication network based on the power saving potential associated with the another power consumption policy; and
receiving, by the processor, from the management unit, a positive acknowledgement for the another power consumption policy.

8. The method as claimed in claim 1, wherein the communication between the radio unit and the distributed unit is via one of: a management-plane (M-plane) based communication, and a control-plane (C-plane) based communication, based on a symbol level power control mechanism, wherein the communication between the radio unit and the distributed unit is via the M-plane based communication based on the symbol level power control mechanism being disabled, and wherein the communication between the radio unit and the distributed unit is via the C-plane based communication based on the symbol level power control mechanism being enabled.

9. The method as claimed in claim 8, wherein the set of parameters for the M-plane based communication comprises at least one of: an identifier of the radio unit, a bit corresponding to the low power state of the radio unit, a type of the power consumption policy, a predicted traffic rate, a number of transmit/receive chains to be disabled, a number of downlink slots to be disabled, a start slot number, and a maximum number of physical resource blocks (PRBs) per each symbol.

10. The method as claimed in claim 8, wherein the C-plane based communication comprises an exchange of C-plane packets between the radio unit and the distributed unit, wherein each C-plane packet comprises at least an extension flag, wherein each C-plane packet comprises extension fields based on the extension flag being enabled, wherein the extension fields comprise at least one of: extension type, extension length, energy saving type, and the set of parameters, and wherein the set of parameters comprise at least one of: number of physical resource blocks (PRBs) per symbol, start slot, and number of slots.

11. A method for managing communication in a wireless communication network, the method comprising:
receiving, by a processor associated with a distributed unit, from a radio unit in the wireless communication network, a set of parameters associated with a power consumption policy of a plurality of power consumption policies;
determining, by the processor, an offset time for a scheduler to change a configuration from a normal scheduling scheme to a new scheduling scheme corresponding to the power consumption policy; and
sending, by the processor, the offset time to the radio unit to enter a low power state based on applying the power consumption policy on completion of the offset time.

12. The method as claimed in claim 11, comprising:
determining, by the processor, a predicted downlink traffic at the radio unit;
sending, by the processor, an indication to the scheduler to change the configuration from the new scheduling scheme to the normal scheduling scheme based on the predicted downlink traffic;
sending, by the processor, a message to the radio unit to switch from the low power state to a normal state based on the predicted downlink traffic;
determining, by the processor, another power consumption policy from the plurality of power consumption policies for the radio unit based on a current downlink traffic and the predicted downlink traffic;
communicating, by the processor, the another power consumption policy to the radio unit;
receiving, by the processor, from the radio unit, an acknowledgement for the another power consumption policy;
determining, by the processor, an updated set of parameters associated with the another power consumption policy and an updated offset time for the scheduler to change the configuration from the normal scheduling scheme to the new scheduling scheme; and
sending, by the processor, the updated offset time to the radio unit to enter the low power state based on applying the another power consumption policy on completion of the updated offset time.

13. The method as claimed in claim 11, wherein the communication between the distributed unit and the radio unit is via a management-plane (M-plane) based communication based on a symbol level power control mechanism being disabled, and via a control-plane (C-plane) based communication based on the symbol level power control mechanism being enabled.

14. The method as claimed in claim 13, wherein the C-plane based communication comprises exchange of C-plane packets between the radio unit and the distributed unit, wherein each C-plane packet comprises at least an extension flag, wherein each C-plane packet comprises extension fields based on the extension flag being enabled, wherein the extension fields comprise at least one of: extension type, extension length, energy saving type, and the set of parameters, and wherein the set of parameters comprise at least one of: number of physical resource blocks (PRBs) per symbol, start slot, and number of slots.

15. A method for managing communication in a wireless communication network, the method comprising:
monitoring, by a processor associated with a management unit, a downlink traffic at a radio unit in the wireless communication network;
determining, by the processor, a low traffic state of the radio state based on a pre-defined threshold for the monitored downlink traffic;
determining, by the processor, a power consumption policy from a plurality of power consumption policies and a set of parameters associated with the determined power consumption policy for the radio unit to enter a low power state based on the determined low traffic state; and
communicating, by the processor, the determined power consumption policy and the set of parameters to the radio unit.

16. The method as claimed in claim 15, comprising:
receiving, by the processor, an acknowledgement for the power consumption policy from the radio unit.

17. The method as claimed in claim 15, comprising:
receiving, by the processor, from the radio unit, a message indicating another power consumption policy from the plurality of power consumption policies based on a power saving potential associated with the another power consumption policy; and
sending, by the processor, an acknowledgement for the another power consumption policy to the radio unit, wherein the acknowledgment comprises one of: a positive acknowledgement or a negative acknowledgement.

18. A radio unit for managing communication in a wireless communication network, the radio unit comprising:
a processor; and
a memory coupled to the processor, wherein the memory comprises processor-executable instructions, which when executed by the processor, cause the processor to:
monitor a downlink traffic at the radio unit in the wireless communication network;
determine a low traffic state of the radio unit based on a pre-defined threshold for the monitored downlink traffic for a pre-configured time period;
identify a power consumption policy from a plurality of power consumption policies for the radio unit to enter a low power state based on the determined low traffic state;
communicate the identified power consumption policy and a set of parameters associated with the identified power consumption policy to a distributed unit in the wireless communication network;
receive, from the distributed unit, an offset time for the radio unit to enter the low power state, the offset time being based on the set of parameters associated with the identified power consumption policy; and
apply the power consumption policy at the radio unit on completion of the offset time received from the distributed unit.
